(19) United States
(12) Patent Application Publication
(10) Pub. No.: US 2006/0200411 A1
(43) Pub. Date: Sep. 7, 2006

(54) Investment System

(76) Inventors: Frederick Morgenstern, Clearwater, FL (US); Thomas Leonard, Clearwater, FL (US)

Correspondence Address: JOHN C. SMITH, ESQ., 2499 GLADES ROAD, SUITE 113, BOCA RATON, FL, 33431, US

(21) Appl. No.: 11/307,126

(22) Filed: Jan. 24, 2006

Related U.S. Application Data
(60) Provisional application No. 60/593,552, filed on Jan. 25, 2005.

(51) Int. Cl. G06Q 40/00

(52) U.S. Cl. 705/43

(57) ABSTRACT

A multilayer geocentric participation system which distributes a variety of products (“e-pipeline” products) to enrolled members and others via electronic (i.e. Internet) participation channels, and provides a variety of financial products, including ATMs, and debit/credit cards. The system determines source of financial transactions and e-pipeline purchases and relates them to particular enrolled members. Compensation is made to the enrolled members as a result of the financial transactions and/or e-pipeline purchases based on the relationship between the enrolled member and the entity making the e-pipeline purchase and/or financial transaction. Participant access keys (“PAKs”) are used to determine the rights of each entity based on individual contracts between the entities.

### CROSS-REFERENCE TO RELATED APPLICATIONS

This application is related to, and claims the benefit of, the provisional patent application entitled “Investment System,” filed Jan. 25, 2005, bearing U.S. Ser. No. 60/593,552 and naming Frederick Morgenstern and Thomas Leonard, the named inventors herein, as sole inventors, the contents of which is specifically incorporated by reference herein in its entirety.

### BACKGROUND OF THE INVENTION

1. Technical Field

The present invention relates to geocentric participation systems. In particular, it relates to an investment management system based on geocentric participation. It is based on a company architecture having various structures which uses a four dimensional, concentric platform that engages teaming technologies with shareholders in the distribution of goods and services, and also protects shareholder wealth via investment contracts with shareholders. The investment contracts include rights in baskets of securities related to company shares and hedge funds related to multiple initial purchase offers, and which further provides shareholders the rights to purchase goods and services through the company and provides revenue and profit sharing for the shareholders. In addition, management overhead of the corporation is reduced via contracts with third party resource contracts which allow the size of internal management to be vastly reduced, while simultaneously providing a higher level of skilled services and talent than a small company would otherwise have the capability of providing.

2. Background

The prior art methods of staffing and managing a business, raising capital, and protecting shareholder wealth are difficult for new businesses, especially during the startup process. In particular, one problem experienced by new companies is that they do not have the resources to adequately staff the company with high-level, talented individuals. Likewise, even if a startup company could provide high-level individuals at specific posts, it would be highly unlikely that it would have the ability to provide significant depth of resources in terms of high-level individuals. If talented individuals were attracted to the Company's operations and were willing to participate, it is unlikely that the company could leverage the insurance necessary to underwrite the risks associated with limiting the liability of such individuals. It would be desirable to have a method of providing high quality personnel to a company having limited resources, and further providing a depth of resources at a low-cost.

In addition to staffing problems experienced by startup companies in the prior art, shareholders associated with these companies also lack the ability to maximize their security and profits, because their limited resources prevent them from adequately diversifying. Likewise, corporations historically have not taken an interest in encouraging shareholders to actively participate with the corporation for the purpose of improving profitability of the corporation, which in turn improves the shareholders' return on investment. It would be desirable to have a method of allowing shareholders to directly participate in the activities of the company, while simultaneously increasing diversification and the return on investment in the company.

Another problem associated with prior art business structures is that shareholders do not gain, or share in any, any direct benefit from third-party investment opportunities created by the company. It would be desirable to have a method of enhancing shareholder wealth by allowing shareholders to expand their wealth by participating in third-party investment opportunities.

The prior art has provided innumerable business structures, but has failed to provide a structure which allows shareholders to invest in a company, and simultaneously participate, or team with, the company for the purpose of simultaneously improving the value of the company while protecting the value of the shareholder's investment. The prior art, within its numerous structures, has failed to allow shareholders to share directly in the company's revenue and profits based on individual and team production.

### SUMMARY OF THE INVENTION

The present invention provides a repeating, four dimensional, layered business model arranged within a geocentric participation system which allows shareholders to create wealth via growth of share value, to create wealth through direct interaction with the company, to participate directly in revenue and profit sharing, and to create wealth through participation in IPO offerings. The geocentric model provides a variety of products distributed through the company via electronic participation (“e-pipeline” products), and a variety of financial products, including ATMs, debit/credit cards, and a variety of products offered via electronic (i.e. Internet) participation channels. Financial transactions and e-pipeline purchases made directly by the shareholder and, those generated within teaming structures, provide earnings and generate that cash distributions paid to the shareholder based on the transaction volumes personally created by the shareholder or associated teams. In addition to the cash distributions paid as a result of direct shareholder activity, the shareholder also receives cash distributions based on a three layer geocentric referral system. The first layer of the geocentric system provides cash distributions to a shareholder based on financial transactions and e-pipeline purchases by parties (“first layer enrollees”) that are referred to the company by the shareholders. The second layer of the geocentric system provides refunds to a shareholder based on financial transactions and e-pipeline purchases by parties referred to the company by first layer enrollees (“second layer enrollees”). The third layer of the geocentric system provides refunds to a shareholder based on financial transactions and e-pipeline purchases by parties referred to by the company by second layer enrollees (“third layer enrollees”). The e-pipeline products distributed by the company include products that are generally available from third parties, products that are unique to the company, and products which the company has developed for inventors. Part of the development process will be the creation of companies for which public stock offerings shall be made available via initial public offerings (“IPOs”). The company further increases shareholder value, and protects shareholder investments by revenue generated through initial public offerings for products developed by the company, and still further through shareholder options and warrants related to the IPOs. The company's revenue and earnings strategies include returns realized from reinvestment of its shareholder capital.

### BRIEF DESCRIPTION OF THE DRAWINGS

FIG. 1 is a diagram that illustrates the relationship between shareholders, the company, subsidiary organizations, and investment funds.

### DESCRIPTION OF THE PREFERRED EMBODIMENT

Prior to a detailed discussion of the figures, a general overview of a preferred embodiment of the system will be presented. The instant invention provides a system to provide wealth opportunities through participation. The invention requires a willingness to be coached and guided away from current practices. For those who already have wealth strategies in place, they can also gain from access to the advantages and structures provided by participation. There are no places along the wealth spectrum where benefits are not available for participants from the smallest to the largest consumers. This invention is intended to overcome the artificial boundaries surrounding access to wealth generation for everyone.

The invention is arranged in layers, and within these layers, there are integrated sharing and participation technologies designed to produce distinct outcomes specific to the category of each layer. This invention provides a geocentric participation system which allow shareholders to profit by direct investment in company and affiliate stocks, as well as through direct participation in company activities. The shareholders select from a number of investment contracts to obtain specific interests in financial activities of the company. The system monitors activity between the shareholders and the company, and further monitors activity between non-shareholders who were referred to the company by the shareholder. Based on the financial activity by the shareholder and the non-shareholder's work for the company by the shareholder, the system determines revenue distributions and dividends which are then paid to the shareholder.

A second function of the system, which occurs concurrently with the financial activities is the distribution of products via an “e-pipeline commercial exchange.” The e-pipeline is operated as a market exchange. It is an e-commerce portal (i.e.: on an electronic network such as the Internet) designed as a derivative to prior art stock exchanges where goods and services are the commodities rather than stocks and bonds. The e-pipeline includes a clearinghouse for shareholder participants who “post” requests for consumer products and services. The company acts as an agency to seek and find the most favorable price and terms for such goods and services. The e-pipeline provides a variety of products that are marketed via both shareholders and non-shareholders. Its products can be existing products that are distributed through alternative participation channels, or exclusive products developed by the company and sold solely through the pipeline. The company profits through sales of e-pipeline products, as well as through financial gains obtained through IPOs related to products developed by the company. The shareholders profit through cash distributions and dividends related to purchases of e-pipeline products. In addition, the shareholders also profit through investment rights obtained through purchase of investment contracts with the company which allows shareholders to participate in profits related to the IPOs. The company further profits through hedge funds related to e-pipeline products and the IPOs.

As a result of combining shareholder investment combined with incentives for shareholder participation in company activities, the shareholders derive revenue distribution and dividend income from direct purchases and financial transactions with the company, and in addition, they derive financial security from diversification due to their interest and profits related to the IPOs and other monetary and investment strategies.

The system provides four core products; (1) an investment subcontract, (2) geocentric layering, debit/credit cards, e-pipeline access, (3) a commercial exchange, and shareholders equities, (4) shares in the company, the company's subsidiary companies, hedge funds, and companion funds. Each of the core products provides the ability of the shareholder to enhance the shareholder's wealth. In its simplest form, the shareholder enrolls by executing an investment contract with one of the company's subsidiaries. Typically, a shareholder will be given an option of selecting an investment contract that is a basket of securities (also referred to herein as PAKs (participation access keys)) between the shareholder and the company which would provide varying returns and rights.

A general overview of how a PAKs may be structured is as follows:

Each PAKs, regardless of size, has a core portfolio. From the core portfolio, the value added aspects of each PAKs are increased accordingly to meet the enlarged subscription price. The core portfolio of the PAKs includes:

1. The PAKs itself is a registered investment contract. This investment contract is the compliance and securities array terminal for our companion transactions. The only entry into our investment management system (e.g. our interdependent micro-economy) is by the execution of this PAKs contract. Each PAKs, as an investment contract, is a security. Within it is a bundle or basket of securities. The term “companion offerings” will be used to reference of our aggregate securities array.

2. The core (hereinafter “PAKs A”) of each PAKs is:

a) an investment subcontract that is a license and revenue-sharing subcontract to the PAKs contract and is the securities housing for the PAKs securities basket;

b) a company ATM card receiving a projected 2% cash distribution on individual spending by enrollee/shareholder;

c) an access key for the company e-pipeline commercial exchange opening only personal spending retail savings;

d) a share basket having the following shares:

i) one share of company common stock;

ii) one share of the company subsidiary LLC member ownership units;

iii) one share of the company fund of hedge funds stock;

iv) matching warrants rights consistent with the company disclosure documents;

5) Financial management account package. Each account within the package must be activated, as does an ATM card, with an opening deposit placed by the enrollee/shareholder. The financial management account package includes:

a) a no risk savings account;

b) a money market account

c) a brokerage account (where their share basket is deposited, and where their liquidation syndicate agreement is lodged);

6) Information request and services package;

a) a company wealth manual discussing company financial planning and personal financing resources;

b) information and membership subscription for company nonprofit foundation for charitable initiatives and invitations;

c) brochure providing support for opening a 401 (k) or equivalent account;

d) an insurance questionnaire and profiler;

e) an estate planning request for information booklet;

f) details on how to upgrade to a higher cost Paks during 30-day option period.

In the preferred embodiment, it is envisioned all of the foregoing options would be accessible through the enrollee/shareholder access fees at the company web site. Further, the foregoing was a description of the preferred embodiment of the core PAKs minimum configuration. All other PAKs or built from this minimum configuration. In addition, all shares referenced are publicly traded throughout; with the exception of the LLC. In addition to PAKs A, the following upgrade PAKs are available:

PAKs B: Contains all of the core PAKs features (PAKs A) plus:

7) a personal website which is linked to company website and provided with back office computer and accounting support;

8) a set of financial access tools and utilities, including access keys for educational support products;

9) a company debit/credit bankcard receiving 2-3% cash distributions on personal usage;

10) a company teaming participation agreement receiving 2-4% cash distributions on all enrollee team usage of the cards (ATM and debit/credit) and e-pipeline commercial exchange transactions;

11) an enhanced share basket to include the following:

a) one share of company affiliate investment company common stock;

b) one share of companion funds; fund 1;

c) one share of companion funds; fund 2;

d) one share of companion funds; fund 3;

e) matching warrants rights package issued consistent with each issuers disclosure statement

PAKs C: Has all the features of PAKs A and B, plus:

12) a company training manual and one-on-one coaching access (Internet webcam)

13) a teaming growth program; expanded business opportunities access

14) enhanced share basket to include the following:

a) one share of companion funds; fund 4;

b) one share of companion funds; fund 5;

c) one share of companion funds; fund 6;

d) one share of companion funds; fund 7;

e) a matching warrants rights package issued consistent with each user's disclosure statement;

f) ten funded forward position options for each company/fund IPO in PAKs basket;

g) one additional member share of company LLC subsidiary.

Before proceeding to PAKs D and E, it is useful to clarify the PAKs first core product and what specifics the investment subcontract includes and does not include for certain PAKs. By way of example, starting with PAKs A, and therefore, the specifics that make up the core of the investment subcontract, the basic contract features are:

i) the enrollee/shareholder has executed a PAKs subscription agreement and paid $29.00 or more for this subscription.

ii) the enrollee/shareholder has executed a license agreement choosing a license category that matches their subscription layer. The minimum license agreement is choosing to participate in geocentric participation or not to participate. A $29.00 subscriber is licensed to share about the company and invite others to participate. A $29.00 subscriber, by choosing the minimum subscription, has chosen not to participate in geocentric participation systems.

iii) the minimum subscription does include, in the investment subcontract, revenue sharing from the personal and individual spending of the enrollee/subscriber, according to the PAKs distribution formulas and guidelines.

iv) The minimum subcontract ($29.00 or more) generated from the PAKs registered investment contract, is between the enrollee/subscriber and the company, its LLC subsidiary, and the company hedge fund. It is emphasized again that no enrollee/subscriber can become a shareholder without executing a PAKs registered investment contract and a first core product investment subcontract. No securities are issued, or may be issued, except those purchased on the public market exchange, without executing the investment contracts. Subscribers to the SCSN, in order to convert to shares, in the event the Lender chooses to do so, must also execute the two investment contracts. The dual investment contracts act as compliance and qualifying terminals for enrollee/subscribers who become enrollee/shareholders. It is also important to recognize that a shareholder who purchases shares on the public markets, is not a PAKs participant. The company has developed an invitation program through its compliance department to access public acquired shareholders. In situations where public shares are purchased by pension plans or other institutional investors, the design includes a system available for such investors where PAKs benefits and participation may be accessible for members or shareholders of the institutional investor. This system is engineered to allow the investor and each individual to have a value added investment resulting from the institutional investor's decision to purchase shares of the company and its affiliates securities. The system is design to resolve conflict of interest issues within such investment formats.

v) The step-up PAKs, beginning at $89.00 or more, include the minimum package as stated above; plus, enrollment into the company geocentric participation systems and teaming technologies. This package includes coaching tools and education support services to operate and expand the advantages of participation. The option to construct teaming layers and boost revenue and profit sharing options has no arbitrary barriers or limits. The extent of these advantages is determined by the participants; not the company.

vi) PAKs are better understood as a hybrid commercial product. They are specifically styled for consumers who are now wasting disposable income on impulse or non-essential spending. This means that the minimum PAKs are $29.00 or more, stepping up from there, $89.00 or more, $289.00 or more, $1,089.00 or more, and $10,089.00 or more. There is no maximum PAKs investment. The “or more” language is an important element of the design. This presents the individual weighing enrollment with an understanding of the scope of the choice to participate. It also is a basic element in how live PAKs will need to be published moment to moment once the company and its affiliates shares are trading (Live PAKs=live market PAKs as discussed herein.) The “or more” element lets the individual considering enrollment understand what he or she is leaving on the table by not investing more in themselves. PAKs from $289.00 or more may also customized. The enrollee subscriber may choose additional securities and subscribe accordingly to fill in the gap between $289.00 and $1,089.00. This same flexibility occurs from $1,089.00 to $10,089.00. Above $10,089.00, all PAKs are custom designed according to the subscriber's investment portfolio and objectives.

vii) The other distinction between the minimum PAKs and the $89.00 PAKs is the degree of revenue and profit sharing. As to the card system, the minimum participates only in individual spending revenue sharing distributions. Beyond the minimum, the revenue sharing option expands to teaming production and markup participations earned from the e-pipeline commercial exchange. The minimum subscription only benefits from access to personal retail savings found on the e-pipeline.

viii) Returning to the PAKs registered investment contract, it is important to note that these contracts are initiated by the company LLC subsidiary that invites the other executing parties to the contract to participate. Above the minimum PAKs ($29.00 or more), the investment company affiliates and its companion funds (first three at $89.00 or more, then all seven beginning at $289.00 or more. These added parties enhance the contract at each degree and, the options for participation distributions and company dividends expand accordingly.

ix) PAKs D and E are distinguished by share mix and add-ons; including website features and company training materials and referrals designed to rapidly expand teaming participation. Company incentives are joined with expanded forward position warrants for each of the company and its affiliate IPO's. Custom portfolio advisory services are provided and well as creating platforms for financial and estate planning and expanded insurance services. The $10,089.00 PAKs include all PAKs D features plus territorial office/training responsibilities and expanded revenue and profit sharing options. Again, this PAKs is primarily customized for the enrollee/subscriber. It is noted that the pricing of the PAKs having the $89.00 added to the PAKs face amount is to underline that enrollee/subscribers pay for all parts of the PAKs as these aspects step up. This reflects the price paid for the features of each PAKs at each price point. In the preferred embodiment, there are no discounts; a subscriber may always pay more, but never less for what is included in the PAKs.

Those skilled in the art will recognize the many variations can be made in designing packs. For example, the prices and other options used in the illustration of the preferred embodiments can vary. The following example is provided to illustrate how such a PAK might be structured:

1. PAK A—$29, entitles a shareholder (“enrollee”) to:

A. Company investment contract.

B. Company ATM bank card receiving 2% cash refunds on spending by enrollee.

C. Company e-pipeline products receiving personal retail savings.

D. Company share of publicly trading company stock and company shares of publicly traded investment company. In addition Company Warrants A @70%

2. PAK B—$89, entitles a shareholder (“enrollee”) to:

A. Personal website with back office computer support and accounting.

B. Company investment contract.

C. Company ATM bank card receiving 2% cash refunds on personal usage.

D. Company Debit/Credit bank card receiving 2%-3% cash refunds on personal usage.

E. Company Teaming Agreement receiving 2%-4% cash refunds on all enrollee team usage of the cards (ATM & Debit/Credit) and e-pipeline products.

F. Share of company publicly traded company stock.

G. Share of company publicly traded Investment Company.

H. Share of company publicly traded Hedge Funds.

I. 4 shares of company publicly traded companion funds.

J. Company Warrants A @70%.

K. Hedge Fund Warrant A.

L. Warrants based on an initial IPO @$5 per share.

3. PAK C—$250, entitles a shareholder (“enrollee”) to:

A. Same as PAK B plus:

B. Additional company stock.

C. Additional company Warrants A @70%.

4. PAK D—$1,000, entitles a shareholder (“enrollee”) to:

A. Same as PAK B plus:

B. Additional company stock.

C. Additional company Warrants A @70%.

D. Additional hedge fund Warrants A @70%.

E. company Training Manual.

5. PAK E—$10,000, entitles a shareholder (“enrollee”) to:

A. Same as PAK B plus:

B. Additional company stock.

C. Additional company Warrants A @70%.

D. Additional hedge fund Warrants A @70%.

E. Additional Companion Investments.

F. Company Training Manual.

G. Territorial office/training responsibilities.

In addition to the foregoing, by executing financial transactions and/or purchasing e-pipeline products, enrollees will earn qualified cash distributions individually and/or through teaming production according to the following formula.

1. 2%-3% cash distribution to enrollee for use of the company's, or company's subsidiaries, debit/credit card, and purchase of e-pipeline products.

2. 2% cash distribution to enrollee on the usage of the company's, or company's subsidiaries, ATM, debit/credit card and purchase of e-pipeline products on all those that are referred to the company, or company's subsidiaries, by the enrollee. (This is the first layer of the geocentric model.)

3. 1% cash distribution to enrollee on the usage of the company's, or company's subsidiaries, ATM, debit/credit card and e-pipeline products on all those that are referred to the company, or company's subsidiaries, by the enrollee's first layer enrollees. (This is the second layer of the geocentric model.)

4. 1% cash distribution to enrollee on the usage of the company's, or company's subsidiaries, ATM, debit/credit card and e-pipeline products on all those that are referred to the company, or company's subsidiaries, by the enrollee's second layer enrollees. (This is the third layer of the geocentric model.)

The e-pipeline is intended to provide products that our shareholders request and new products developed by the company. The pipeline provides an advantage to the shareholders because the company can negotiate better prices based on its ability to order large quantities. As part of the e-pipeline design, the company will seek out and evaluate new products for development by the company, and distributed through the e-pipeline.

The foregoing four core products form a system that provides value to shareholders by reducing their cost, and by increasing their wealth through IPO gains created by delivering new technology products through the e-pipeline. The system is called geocentric participation because it's based on layers projected from the center (company) in a three layer platform that grows through direct spending by shareholders, and teaming with referred shareholders that increases income and preserves wealth for the shareholder.

Those skilled in the art will recognize that the foregoing example is intended for illustrative purposes only. For example, the revenue-sharing and profit-sharing distribution schedules, as well as company dividends can be anything suitable for particular e-pipeline product line. In addition, the number and types of PAKs can vary. Having discussed the invention in general, we turn now to a more detailed discussion of the figures.

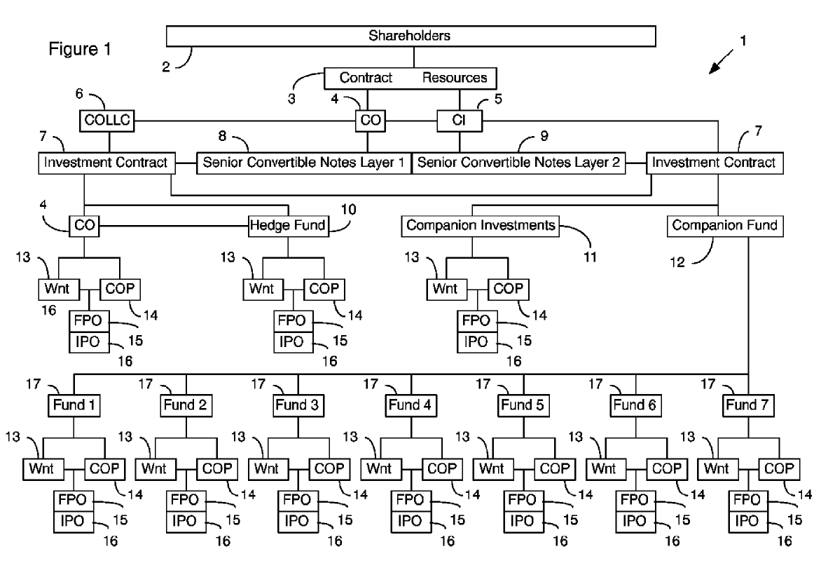

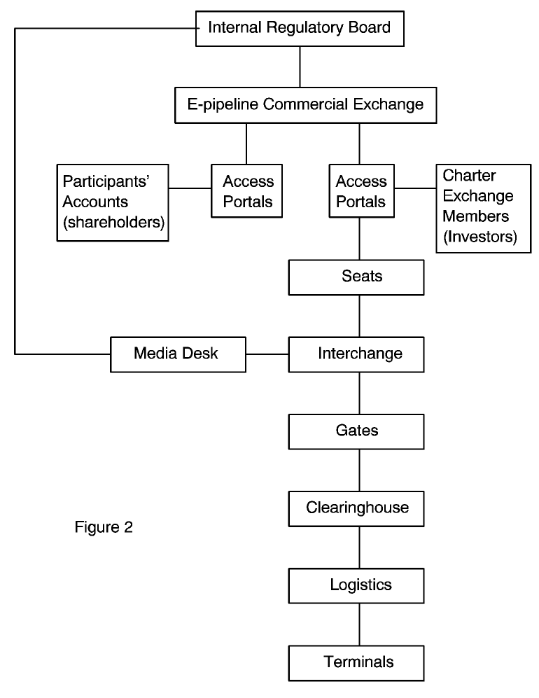

FIG. 1 is a block diagram of a preferred embodiment of the investment management system 1. In the figure, the shareholders 2 represent shareholders who have entered into investment contracts 7 (i.e., enrolled in PAKs. Shareholders 2 have PAKs as investment contracts 7 with company 4 and its subsidiary (COLLC 6) and a separate related company Cl 5 which is fund management director of the companion companies securities design and array. In addition the Company 4 and Cl 5 also have contracts between one another as indicated in the figure.

The benefit of having two companies (CO 4 and Cl 5), rather than have everything run by a single company, is as follows. The population of shareholders occurs from two sources: PAKs enrollments and, once the company is publicly traded, from the general public market exchange. Focusing on the PAKs participants, each PAKs, from the $29.00 up, have embedded shares from CO 4 and Cl 5 and. incidentally, COLLC 6. The shareholders own and operate the company so, from an organizational accountability context, the shareholders are at the top. The common shareholders of the three entities is the first interrelationship. However, the expertise and operations management for the design, and therefore, all the companies, comes from contract resources. Although, each of the contract resources providers as entities or individuals are also shareholders, the responsibilities and accountability for operations performance and deliverables is structurally under the Shareholders.

CO 4 is the parent company of COLLC 6 and Hedge Fund 10. CO 4 is a to be public company as is Hedge Fund 10. COLLC 6 is a private company where the referenced shareholders above are; members. COLLC 6 is chosen as the income side of the CO 4 operations and CO 4/Hedge Fund 10 are the equities and growth side of the transaction. COLLC 4, are the investment contract issuer for its members, who are treated as independent contractors, and are therefore and are therefore taxed under the LLC benefit structure rather than as a corporate structure. This also means that the ultimate net profits of COLLC 6 flow upstream to the parent CO 4 and post directly to the bottom line of CO 4 without further reduction for costs of goods sold or operations expenses. This bottom line enhancement reduces accounting issues within the public company and goes right to net book value thereby underpinning the equity value of CO 4. This improves the performance of CO 4 and reflects its purposes as an equity growth vehicle, not as a cost heavy earnings center. Since the public reporting requirements are audited monthly, this structure provides a more accurate audit trail. Rather than publishing enormous gross revenue with a small bottom line, the CO 4 financial statements reflect net earnings from its subsidiary. The financial analysis of this reporting and how it cleans up the financial statement for public reporting purposes is advantageous in both the market's perception of CO 4's value and it is an accommodation for regulators as well. This does not imply, nor lessen, the rigorous and elaborate accounting systems required for COLLC 6. In fact, it intensifies the need for perfect work in the COLLC 6 accounting department. This is necessary also for the integrity of the geocentric participation and earnings layers to be properly accounted for and distributions made.

To continue, CO 4 functions as the operations center for the overall transaction. It is a standard corporation that may, for more stringent compliance reasons, become a registered investment advisor. Support for this likelihood is its ownership of Hedge Fund 10. Hedge Fund 10 is a publicly traded fund and is to be registered as a fund of hedge funds under recent rulings by the SEC. A fund of hedge funds is a more conservative hedge fund type and is appropriate for making smaller investments per shareholder.

The purpose of Hedge Fund 10 (GainShare Essential Hedge Fund, Inc.) is consistent with the structure in that it builds equity value and it enhances CO 4's balance sheet in various ways. Its earnings flow upstream to CO 4, as all subsidiary net income does. Again, as was the case with COLLC 6, cleared net earnings move up to the parent's bottom line. Also, the equity portion of the Hedge Fund 10 that CO 4 holds, as it gains or declines in value, is expressed as an increase or decrease of net assets. Again, a strong balance sheet enhancement (on the upside) for CO 4. On the downside, changes in equity values do not affect earnings (as a reporting item for market analysis as to current performance). This allows CO 4 to benefit in the upside as to earnings and equity. On the downside, the only change would be an equity devaluation but this would not erode CO 4's earnings since losses remain with the subsidiaries in the current period.

In regard to Cl 5 and CO 4, to be stand alone companies and why one company cannot run everything. Cl 5 is a registered investment company (40's Act) and engaged in the investment arena; not commercial. It is a stand alone affiliate. In particular, CO 4 is offering monetary and investment products as commercial product types. The four core products are blends of securities and commercial products. Cl 5 is strictly involved in the investment arena (in a coined commercial niche category: Consumer merchant banking.) As a publicly traded investment company, it is regulated differently than a standard public company. Part of the interrelationship of Cl 5 and CO 4 is PAKs from $89.00 and more have embedded shares from Cl 5 and its affiliates (companion funds). Also, and this explains the division in the shareholders box and the contract resources box, the consolidated entities all have some portion of shareholders that are common and, it is likely that a portion of the contract resources engaged may be contracted with by several, or all, of the entities. This explains why IC 7, although placed on both sides of the chart, may have contractors holding IC 7's unique to one side and to the other side concurrently.

In summary, neither a single company, nor a single security, may offer the unique and distinct operations features and compliance requirements offered by our array. Each entity operates in a domain of diverse elements and an interrelationship accomplished with precise management and accountability. To a serious degree, the engineering of this array is founded in allowing each company to excel and present its financial results accurately to market analysis to otherwise cause the stock of each company to be market desirable. The remainder of reasons and explanations are subordinate to this financial engineering. A single entity cannot operate in the diverse domains identified within our operations and products mix, because the securities regulations prohibit collapsed integration where co-mingling of funds and reallocated use of proceeds are common errors in developing and mature companies. The prime benefit of the two operations is that each company is in a separate industry answering to different regulatory and compliance structures.

The company 4 also owns a subsidiary COLLC 6. The subsidiary COLLC 6 which has an investment contract 7 with the company 4 and with a hedge fund 10.

The investment contract 7 boxes are not control centers; they are terminals. The entry point into the system is enrollment through the execution of a subscription agreement that includes the disclosure materials. It could be represented on a flow chart that the PAKs are at the top of our structure since it is the only way to become involved. The exceptions to this are purchasing shares, once publicly traded, on the market exchange; or currently, subscription of Senior Convertible Secured Notes (SCSN). Both of these entry types are invited, through our compliance department, to participate in our PAKs program. This is a resourcing area that is intended to be defined so as to otherwise include these shareholders in geocentric participation and teaming technologies. Because our PAKs are the primary entry vehicle; and, PAKs are in themselves investment contracts with an investment subcontract embedded within each: as a core product, the boxes on the figure represent these documents and actions. The challenge in the chart's composition is where to put the investment contract 7 boxes to reflect their importance and function. This is why they are connected with each other in the figure. One box is prepared by CO 4 and its subsidiary COLLC 6, as two parties entering into one investment contract with a subscriber having earnings, license, participation and equity features; and, the other investment contract 7, is prepared by GainShare Companion Investments, Inc. (Cl 5) with the same or separate subscriber depending on the PAKs features and inclusions. The Cl 5 investment contract has license and equities based features only. To connect this with the actual, PAKs are available for $29.00 or more. The $29.00 PAKs have three stocks embedded, one share of common stock (initially issued as certificates of participation that are convertible to common stock when the respective registration statement becomes effective; except COLLC 6 is a private company which allows these shares to be issued, but also under the disclosure materials listed above, in each of CO 4, COLLC 6 and Hedge Fund 10. All PAKs from $89.00 or more, have each of the $29.00 array; plus shares from Cl 5 and up to seven companion funds shares (beginning at $89.00 with four funds, one share each). Above $89.00, one share each of the seven companion funds (also issued as certificates of participation under the same discussion as above).

Where the chart divides into the lower section; indicated by that portion coming from the right and left IC 7 and below the lateral then perpendicular lines leading to the array: CO 4, hedge fund 10, companion investment 11, and companion funds 12, the chart becomes a securities issuing array. Cl 5 and Companion Investments 11 are the same company and companion funds 12 is a fund management accountability function. It is the fund manager for the seven registered diversified companion funds. This could be an outside fund management firm; which is preferred. Should system become large enough, this may, at some point become a subsidiary entity to GainShare Companion Investments, Inc. It represents the fund management arm of GainShare Companion Investments, Inc. (Cl 5). The upper portion or the chart is the structural and operational origins of the system. The lines in the figure, therefore, are operational lines but not structural control lines. CO 4 and Cl 5 control the downward lines and boxes. So, from a control standpoint, the investment contract 7 boxes are invisible as to operations but, a subscriber (as a PAKs) participant cannot move to the securities section without executing the investment contracts and a liquidation Syndicate Agreement which is embedded in the investment subcontract (first core product). This is why investment contract 7 (IC 7) are terminals, not control centers. CO 4, therefore, controls COLLC 6 and hedge fund 10 and itself; not the investment contracts 7. There is no way to be a shareholder, except as explained above as to public shares and SCSN, without executing the IC 7(s).

In addition to the preferred embodiment, discussed above, an alternative preferred embodiment will be presented below.

This portion of the discussion of the preferred embodiment is related to its design elements. This embodiment incorporates four primary design changes. These are:

1) the setting aside of any interpretation that the invention is an MLM scheme (a network marketing scheme), and

2) the redesign of the PAKs whereby shares embedded in the PAKs are a class of common stock included without charge, and

3) the use of a corporate promissory note to attract the initial funding required, and

4) the replacement revenue sources for the PAKs that were once revenue and equity generators, are now given to a predetermined number of charter participants for free.

The first element defines the true character of the invention, and establishes the invention as having no relationship to an MLM or Network Marketing scheme. Distinguishing the features of the invention from an MLM requires minimal effort. The essential elements for an MLM to exist are:

1) pay a front end fee to either belong to something or to buy something, and

2) invite others to do the same so that a downline is created, and

3) say that no selling is involved even though there are no ways to earn except by selling.

For accomplishing these three elements, the owner of the downline gets paid as other repeat the same three elements for themselves. The test that a MLM exists is to verify how those involved are paid. Generally, this is based on formulas where percentages of front end fees and sales of hyper-retail products or services are distributed in declining amounts from top to bottom of a downline. The entire basis for payment is on a declining percentage schedule, from top to bottom, from MLM signups and sales of the MLM's products and services.

In contrast, the invention is a Geocentric Earnings Matrix (GEM). In its simplest description, the preferred embodiment of the GEM is a seven layer computation structure utilizing a four dimensional integration approach. This structure engages a myriad of variables and derivatives to capture participation and earnings events generated by eighteen inputs. Those skilled in the art will recognize that while the preferred embodiment of the GEM uses 18 inputs, it is intended to be flexible. Therefore, additional inputs are possible. The eighteen inputs are created from measures of participation, with dedicated metrics for time, spending, purchase savings, team building, and wealth portfolio construction events. Each of these categories have computations that expand from active to cumulative, and have integrations for the length of time the participant is engaged with the GEM. As the GEM enlarges, categories are added for team formation, sustained growth, spending, purchase savings, production volume, and wealth portfolio expansions. Each of these categorical inputs creates separate earnings options and centers for participants.

The application of these metrics, and the input of the computations into the GEM, are collected within the seven layers, and are treated as internal attainments. In addition to earnings generated within the GEM, shareholders also receive declared quarterly dividends consistent with their individual equity holdings. Earnings, paid as rebates, revenue sharing units (RSUs), account generated interest, plus dividends, require thirty days segment participation, are computed on an average daily balance basis, reconciled monthly, and are disbursed in arrears.

The complexity of the Geocentric Earnings Matrix (GEM) can be more easily understood by recognizing its functions and defining its unique pieces. The GEM is a layering mechanism in which eighteen inputs contribute to advancing within the geocentric environment. The primary metrics are divided into nine individual measurements, and nine team measurements. The number of choices where a shareholder chooses to participate determines the number of ways the shareholder earns. The shareholder may earn individually, or as a member of a team. The shareholder participates with a team, and the shareholder may choose to form a team. The purpose for the teams is to consolidate interests and requests to the system and the marketplace. Teams are earning centers for the system, and for the shareholders who make up the teams.

The advantages gained within a team structure include enlarged purchasing capacities and increasing leverage in the commercial marketplace. This, in turn, enhances equity values. In the preferred embodiment, the company is owned and operated by the shareholders. Ownership has its advantages. When the individual earns, the team earns, the company earns, the shareholders earn. This creates an environment measured in four dimensions. The eighteen inputs are derived from production results in each of the four dimensions. There are earnings options based on point-of-purchase card usage, time with the system, time on a team, individual and team rate of growth, volume of growth, and diversity of growth. Because the system creates its own interdependent micro-economy (IME), it is a demand position (buyers) economy, not a supply sector (sellers) economy. There is nothing to sell at the system; there are only options to save, buy, and earn. The shareholder gets paid to spend, earns from the amount of purchase savings gained, and saves by purchasing within the interdependent micro-economy rather than spending elsewhere. The system is dedicated to preserving the wealth of its shareholders. Within the eighteen inputs are wealth measurements and invitations. There are metrics for portfolio growth and sustaining this growth by increasing savings, investment purchases, and money deposits.

Each shareholder and shareholder team is open to choose a personal wealth preservation strategy leading to having essential wealth, cumulative wealth, optimum wealth, or permanent wealth. The system provides the financial tools and the development structures to cause these objectives to occur for those who choose to participate in these wealth preservation strategies. The system, as an entity engaged in consumer investment banking, intends to protect and grow the wealth options for its shareholders.

The differences between the system and an MLM or Network Marketing scheme are substantial. For example, the test for an MLM is to verify how the participants get paid. MLMs use geometric progressions. The GEM is propelled by calculus. No shareholder pays a front end fee. MLMs always have a front end fee or cost. No shareholder must form a team in order to earn, and a team is not a downline. There are no downlines in the GEM. Likewise, there is no selling in the GEM. The GEM is not in the product business. It is in the money business. Gem shareholders are demand position buyers; never supply sector sellers. A GEM shareholder does not have to invite others to become involved in order to earn. In contrast, all MLMs are built on the premise of inviting others to become involved and have those who accept pay a front end fee and buy products. In a GEM, when there is something to buy, the individual shareholder, the shareholder's team, and the GEM earns. This is appropriate since the individual shareholders and the shareholder teams own the company.

The second element of this embodiment of the invention offers the redesign of the Participation Access Keys (PAKs), featuring the opportunity to receive Class A common shares free. To appreciate the PAKs as they delivery vehicle to reach the system environment, a snapshot of the environment is useful. Participation Access Keys are self-defining. In order to participate within the interdependent micro-economy, the participant must be a shareholder. When an element embedded in a PAK is activated, the participant becomes a shareholder for free. The PAKs have access codes that are required to trade on the e-pipeline commercial exchange. The codes are keys to the internal environment of the system. Only shareholders are permitted to operate inside the system. Likewise, the system is open to everyone who wishes to accept an invitation to join.

The PAKs are invitations for others to look inside the interdependent micro-economy (IME). If what is seen there is useful for the person looking, he or she is invited to activate a feature, or all the features embedded within the PAKs. When at least one feature is activated, the access keys within the PAKs are initialized. This permits access and navigation within our website; including access to the e-pipeline commercial exchange. After the first thirty days, the shares are deposited into the shareholder's brokerage account within the system and, depending upon what features the shareholder has chosen, entry into the Geocentric Earnings Matrix pays the shareholder's first thirty days earnings; gained from Layer 1 rebates, plus Layer 2 and Layer 3 Cumulative Time payments. It is necessary to add several structural pieces to these descriptions.

Along the spectrum of economic activities, there are macro-economic systems, such as states and nations. Within these, there are numerous micro-economic systems, some smaller, some larger. Micro-economic structures are dependent upon the larger influences emanating from the macro-economic systems. The creation of an interdependent micro-economy is accomplished by forming a closed system where the participants are dependent upon the interactions of the other participants within the closed system. The created micro-economy remains dependent upon the larger macro-economic systems, but it profits from internal economic interactions by controlling access to its closed systems, and by using its consolidated population's leverage to impact supply.

To further define an interdependent micro-economy, it is necessary to understand the nature of an economy. Primarily, and economy is simply an environment, operating within the balance of supply and demand, that is influenced by various internal and external dynamics. An economy is measured in specific cycles that are generated by shifts in the wants and needs of consumers, the availability, scarcity, or abundance of raw materials, commodities, goods, services, and currencies, the purchase and selling prices of each of these, the measure of satisfaction of consumers, manufacturers, and suppliers with these prices, and how these prices impact the costs and the factors of production. It is the dynamics of an economic system that creates an economy, and the economic options available, within the aggregate macro-economic and the micro-economic systems. The entry into the GEM micro-economic system offers participants access to the consolidated economic systems, not as an individual, but as a population seeking, and intending to produce, financial independence for each and every shareholder. This is the definition of an interdependent micro-economy.

Moving from the structural elements back to the PAKs description and applications, certain features are included within the PAKs that determine the extent of each shareholder's participation. The entry into the interdependent micro-economy (IME) occurs when an individual accepts the free PAKs, chooses to activate one or more of the point-of-purchase cards, and places the minimum opening deposit in their shareholder account. Each shareholder account is designed as one account having various partitions. Mechanically, it is operated as a main account with a number of sub-accounts. The design for the account includes its operation from the Internet; accessible with the shareholder's access key. From this screen, the convenience of online banking appears, and the shareholder may freely move funds from one partition to another partition with the click and drag of a mouse. An advantage of this account is the ability to access a single account page, and see all the shareholder's account balances on a single screen. This feature enables the shareholder to confirm balances, deposits, withdrawals, and net changes in earnings for the current month, year-to-date, and from the conception of the account. Where a shareholder has selected to open investment accounts, a projection feature is included where, by keying in a particular future date, a window appears showing the value of funds on deposit on the selected future date.

When the shareholder chooses to open one or more accounts, his or her earnings centers are activated. The PAKs offer the shareholder account array, and provide the minimum opening deposit requirements. These actions activate the individual shareholder's participation in the Geocentric Earnings Matrix (GEM). There are eighteen earnings inputs within the GEM, and each shareholder account has access to specific earnings features that are individual to the shareholder. The earnings categories within the GEM include, cash rebates earned from card spending events, purchase savings gained by buying on the e-pipeline commercial exchange, Revenue Sharing Units (RSUs), earned within various layers of participation and production, plus team expansion within the interdependent micro-economy, interest earned on deposits in partitioned accounts, dividends earned on stock positions, equity appreciation, and gains from sale of new or prior owned personal items listed on the e-pipeline commercial exchange.

Before listing and describing each of the elements included in the free PAKs, a brief discussion about the e-pipeline commercial exchange is necessary. The e-pipeline commercial exchange creates a revenue generating resource. The blueprint for the e-pipeline is adapted from a traditional market exchange where stocks or commodities are traded. The e-pipeline intends to create an organized market for the purchase and sale of consumer goods and services. The e-pipeline constructs a ready market, as listings, for these furnished goods and services, including raw materials. The operation of the e-pipeline is in real time and, as a market is made for a listing, there is an immediate sale and liquidity for the listing seller. This immediacy encourages pricing that is market determined, not wholesale or retail based. And preferred embodiment, it is envisioned that a market occurs wherever something is bought and sold. The listings on the e-pipeline are no exception. As the listings expand, the demand for additional listings increases. The e-pipeline creates a pricing mechanism by allocating goods and services based on the response for the demand for the products and services; not based on marketing and supply. This causes pricing to emerge that reflects the true value for the goods and services based on the present value to the buyer. This is the nature of a market price as opposed to a manufacturer's suggested retail price (MSRP). It is the intent in this preferred embodiment that all products and services, including raw materials, are to be eventually traded in markets, not in stores or by wholesale distributors. The e-pipeline creates such a marketplace, treating all listings as commodities, priced and available for immediate sale, as determined by supply, demand, and fulfillment costs. The e-pipeline is not to be confused with an online auction, an e-commerce portal, an electronic mall, a wholesale club, or a manufacturer's outlet store. It is none of these, and accomplishes more than all of these, combined. It is a trading market with listings at bid and ask. The market determines the price. No one else can. It is the e-pipeline commercial exchange.

The structure of Participation Access Keys (PAKs) is guided by current market trends and research into individual and small business choices and circumstances. In the preferred embodiment, the PAKs have nine categories of features and financial enhancements. These are:

1) a new species of point-of-purchase cards and devices having traditional external, and proprietary internal, affinity reward features,

2) partitioned money management accounts,

3) shares of Class A common stock, and/or other securities, that are provided free to a predetermined number of charter shareholders,

4) geocentric participation and teaming technologies captured within the Geocentric Earnings Matrix (GEM),

5) internal rewards points, called Revenue Sharing Units (RSUs), that convert each shareholder's measure of participation and production results into monetary equivalents,

6) access keys for the e-pipeline commercial exchange and for the shareholders only secure pages inside the GEM website,

7) personal capitalization navigator, a guidance system for monetary resolutions, including retirement and estate planning matters, plus small business specialized services,

8) financial services array, including linkages to mortgages, insurance products, and financial planning services, and 9) coaching tools and support utilities to facilitate success within the commercial and investment marketplace, including website integration and e-commerce.

The categories offered, and the components within each category, are selected to offer sufficient reasons for a prospective shareholder to become involved, and to maximize the benefits and advantages once the shareholder is involved. The flexibility of the PAKs' design invites revisions and additions should the market shift to where new elements are preferred. The delivery packages for the PAKs may be accomplished as a brochure type folder, or as a CD/DVD media format having far greater consumer appeal. The PAKs have useful features, rewards, and elements that attract, inform, and invite interested parties to visit the GEM website where wealth preservation and financial enhancement options are fully explained. PAKs are delivery vehicles that carry an individual's initial interest in the system to the options, and to the proofs, for producing their individual financial independence. The Participation Access Keys (PAKs) open the entrance into the interdependent micro-economy where individuals, and small businesses, having the access keys are shareholders.

The considerations for loading the Participation Access Keys (PAKs) with sufficient attractions to satisfy consumer interest leads to the purpose of the system. This purpose is to provide the coaching, the tools, and the access for financial resolutions for consumers. Providing financial resolutions for consumers cannot occur without active monetary and investment structures. Our PAKs are the delivery vehicles for these structures. The accomplishment of these structures requires the establishment of specific investment features that are designed to increase the awareness of the power of money. Also, the operation of monetary and investment structures creates active revenue engines for the system.

In the previous embodiment, the PAKs were planned as direct revenue sources. The prices for the PAKs included a portion dedicated to the purchase of our equity securities, a portion that was sufficient to cover the costs of producing the PAKs, and a portion allocated for overhead and administrative costs. Providing the PAKs for free, including having embedded securities issued for free to the participant who activates at least one of the PAKs features, and maintains the minimum balance or balances consistent with the number of free shares to be issued, eliminates the PAKS as a direct revenue source. To accomplish this, the opening deposit amounts would be raised, and the minimum balance requirements for the first thirty days would be increased. This strategy permits the system to gain interest income by investing these balances in overnight government securities. It is anticipated that a financial arrangement may be contracted with financial institutions offering these types of bundled account services. In the preferred embodiment, a partitioned account is designed to permit the operation of one or more deposit accounts, and several account types, concurrently. This format provides the ability to design and monitor individual financial position and fluctuations.

In the preferred embodiment, a predetermined number of individuals are invited to activate one or more features embedded in the PAKs. The individuals choosing to accept the invitation, and to deposit specific minimum amounts into their partition account, are to receive free system securities commensurate with the account deposit package selected.

The premise of minimum participation is initiated within the first of the nine categories of features and financial enhancements. Each of the remaining eight categories are accessible, but require choices and actions within the first and second categories. The minimum participation an individual may choose is accomplished by depositing a predetermined amount (e.g. $200.00), or more into their demand deposit partition account, activating their Personal Currency cards. These starter cards are an ATM card, and a MasterCard logo debit card. Once this deposit is made, and where an average daily balance of $200.00 or more is maintained for the first thirty days, and the cardholder uses the card in at least three spending transactions, the owner of the account is issued one share of class A common stock and one Warrants A; exercisable at 70% of the current market price of the underlying Class A common stock, once this stock is registered and publicly traded. The Class A common stock issued, including the underlying Warrants A Class A common stock, have attached dividend and registration rights. At the moment the initial deposit is made in one or more of the partition accounts, the individual is treated as a shareholder, and may navigate and utilize the features in all nine categories. Minimum participation involves only the first three.

Beyond the minimum participation within the first category is the option to create a team by requesting PAKs with additional Personal Currency cards to be issued to family members or associates who wish to also become shareholders. Each of these situations would require these individuals to select the minimum participation amounts and accounts. However, the account owner may have additional Personal Currency cards issued to family members drawn on his or her partition account in the event these family members do not elect to immediately become shareholders.

To expand participation within the second category, partitioned money management accounts, the account owner may choose to open the remaining three available accounts; each having minimum opening deposit and average daily balance requirements. The three accounts are intended to introduce the account owner to the advantages found in the monetary and investment account arena. The first of these accounts is a higher yield savings account requiring an initial deposit of $200.00 or more to open the account. Once this deposit is made, and where an average daily balance of $200.00 or more is maintained for the first thirty days, the account owner is issued one share of Class A common stock and one 70% Warrants A having the same exercise provisions as the Warrants A granted with the Personal Currency demand deposit account. The higher yields earned from this account are the result of the systems' investment of the balances in overnight government securities where the yields earned are split, preferably 50/50, between the account owner and the system.

The second account in the three account array is a money market investment account. This account requires a minimum initial deposit (e.g. $200.00), or more, to open the account, and where an average predetermined daily balance is maintained for the first thirty days, the account owner is issued one share of Class A common stock and one 70% Warrants A having the identical features and exercise provisions as previously described. The account owner may choose to link this account to his or her Personal Currency demand deposit account for larger or specific purchases requiring a PIN entry.

The third account in the partitioned money management accounts array is a brokerage account. This account is opened for the account owner concurrent with the issuing of the Class A common shares and the 70% Warrants A, after the first thirty days that the partition account minimum average daily balances and the partition account(s) are satisfactorily maintained. The account owner may elect to open this account before the issuing of their securities by placing a predetermined minimum initial deposit (e.g. $400.00), or more, into the account. The account owner may also deposit other securities into this account, and buy and sell securities from this account. There are qualifications, and certain limitations, subject to the third party brokerage agreement negotiated with the firm that is to provide these contracted services for the system. It is anticipated that an additional deposit may be required to trade stocks from this account, and if the account owner requests to trade options, another minimum deposit of a segregated amount (e.g. $3,000.00) is projected for this purpose. If the account owner elects to open the brokerage account before the issuance of their securities, and does this when he or she activates their Personal Currency account, there are additional equity rewards. For example, with a minimum deposit of $400.00 or more, two shares of Class A common stock, and two 70% Warrants A will be issued to the account owner thirty days after a minimum daily balance of at least $400.00 is maintained. The Class A common shares, and the 70% Warrants A, have the identical features and exercise provisions as those prior described. The extended equity rewards are intended to encourage account owners to focus on wealth management and preservation.

The preferred embodiment envisions a gradient rewards scale for a first predetermined number of shareholders, that extends for their first twelve months as shareholders, where initial deposits and maintaining larger average daily balances, in any or all of their four partition accounts, qualifies the account owner to receive additional free shares of Class A common stock and 70% Warrants A. Also, where minimum spending amounts (e.g. $200.00 per month) per Personal Currency card are exceeded, additional reward shares are may be issued. The initial application of the gradient rewards scale includes, for each $200.00 (or other predetermined amount) deposited that results in a $200.00 cumulative increase in the partition account's average daily balance for the current thirty days, the account owner will receive one share of Class A common stock and one 70% Warrants A with identical features and exercise provisions as previously described.

The gradient rewards for spending are based on total monthly spending. This type of gradient reward scale creates an incentive for shareholders to deposit more, to maintain larger average daily balances, and to spend more using their Personal Currency cards. Such a system supports the value Co-Owners places on its shares, and provides the deposits that, when invested in overnight government securities, produces greater yields and earnings for the system and for its shareholders. Also, a gradient reward system encourages individuals in the first row of the announcement, where a predetermined number of charter participants receive free shares of Class A common stock and free 70% Warrants A, when they choose to accept an invitation to join the PAKs, and become shareholders.

It is useful to recall that when the PAKs are received, all the features, rewards, options, and financial enhancements are available once the PAKs are activated with the initial deposit into one or more of the partition accounts. This includes the fourth category, the geocentric and teaming technologies captured within the Geocentric Earnings Matrix (GEM), and the fifth, the internal reward points, called Revenue Sharing Units (RSUs), that convert each shareholder's measure of participation and production results into monetary equivalents. The gradient reward scale enhances the perception that to become involved, something is gained, and once involved, what is gained by the system, is also gained by each individual shareholder as rebates, equity in the system, and dividends paid to the shareholders when declared from the system's earnings.

Categories 1-9 of the PAKs have been introduced and briefly discussed above. The remaining three are described above. All nine of the PAKs' categories are individual revenue engines for the system and for the shareholders. Each category generates earnings, and provides learning options. While there are significant innovations within the nine categories, especially within the e-pipeline commercial exchange, the Geocentric Earnings Matrix (GEM), and the application of the Revenue Sharing Units (RSUs) as internal monetary equivalents (IMEs), the systems' designed versions of monetary and investment accounts and services are competitive with those in the recognized financial services and point-of-purchase card marketplace. Because of these precursors and underpinnings, there is an ease of entry into these industries. The system is not intended to enter the marketplace with more of the same products. It offers enhanced products and superior services from an equity ownership launch point; not simply from a more favorable price point. This dramatic difference and benefits provides individuals with options not presently available in the marketplace.

The summary elements for PAKs construction include a review of the PAKs' features, rewards, options, and financial incentives. The primary purpose for the PAKs, and the free shares provided for the charter participants, is to establish an initial population of shareholders who are urged to receive and use the benefits provided by the system. The categories that make up the PAKs include a wide array of financial vehicles and tools. Becoming a shareholder, by definition, makes an individual an owner. How much may be owned is based on the choices the individual participant makes. There are no imposed limits beyond the number of PAKs having free share offers, and the amount of time that free shares will be rewarded for deposits, average daily balances, and spending. In this embodiment, it is intended that a predetermined number, e.g. 110,000, of charter participants who activate PAKs will become shareholders, and have up to one year to receive free share rewards for deposits, average daily balances, and spending. The free share rewards are based on predetermined cumulative monthly increments, where the prior month, the current month, and the following month determine the number of share rewards. For example, where an initial deposit is made of $200.00, this would establish the initial or prior month. If in the current month, meaning the second thirty days, the account owner deposits $200.00 or more, and the average daily balance equals or exceeds $400.00 for the current month, the account owner would receive one additional share of Class A common stock and one 70% Warrants A at the close of the current month. In the following month, if the account owner deposits another $200.00 or more, and the average daily balance for the month equals or exceeds $600.00, the account owner would receive another share of Class A common stock and one 70% Warrants A. This option to increase the average daily balances month to month by at least $200.00 and receive free securities continues in this fashion up to twelve consecutive months. The prior month, current month, and following month format simply slides forward with the calendar changes. This gradient rewards option is available in all four of the partition accounts the same principle as applied to initial deposits and average daily balances, applies to incremental monthly spending. As to initial deposits, one share of Class A common stock and one 70% Warrants A is rewarded for each $200.00 increment deposited, and that amount that remains in $200.00 increments as an average daily balance, for at least the first thirty days, would receive the applicable gradient share rewards. These initial deposit gradient share rewards apply to all four partition accounts.

To complete the discussion about PAKs, and to highlight the attraction that PAKs bring to the marketplace, attention again is directed to the various categories enclosed within the PAKs. While point-of-purchase card choices are the PAKs' lead features, closer review reveals an extensive and useful structure. The design for the PAKs attempts to create a bridge between what is available in the financial marketplace and the consumer who is interested in achieving financial independence, but who is unclear how this is accomplished. PAKS open the door to a structure where financial independence is possible and achievable. Our array of point-of-purchase cards have competitive spending event rewards matched with most of the other cards in the industry. The exceptions may be premium membership cards. What the PAKs introduce beyond card choices creates the separation of the system from any other card issuer. The nine categories of features, rewards, options, and financial enhancements each contribute to equity value and earnings. In brief, these are the nine categories and the contribution each of the nine benefits of the system and the shareholders.

1. Point-of-Purchase Cards

A new species of point-of-purchase cards and devices. These produce revenue for the system, and for shareholders as they use their cards. Also, earnings are gained from the investment of deposits in overnight government securities. Cardholders benefit from a wide array of spending and savings rewards; the most unique rewards are shares of the system's Class A common stock and 70% Warrants A that are free; subject to minimum initial deposit amounts, and the maintenance of specific average daily balance requirements. All the services available within this demand deposit partition account, with the exception of printed and mailed monthly statements, have a full access fee of $1.75 per month. Electronic and downloadable partition account statements are free.

2. Partitioned Money Management Accounts

Partitioned money management accounts. These accounts create the center for each shareholder's wealth preservation options and choices. There are four partition accounts. The first is the demand deposit partition account for our point of purchase cards, the second is a higher yield savings account, the third is a money market investment account, and the fourth is a brokerage account. Each of these accounts are revenue producing and equity contributing due to sweep management of daily closing balances invested in overnight government securities. Each account offers gradient share rewards based on the initial deposit amounts and the average daily balances maintained in the account(s). Each account, with the exception of the free brokerage account, have a predetermined monthly full access fee of (e.g. $1.75). There are no other charges for the services available within the four partition accounts; with the exception of printed and mailed monthly statements. These are available on request by paying printing and mailing costs. Monthly statements, including cutoff statements, are continuously available electronically, and may be downloaded and printed by the account owner at any time. Each of the four partition accounts has earnings features that benefit the account owner. The demand deposit account, as the source for funds for our Personal Currency card transactions, receives direct deposits of rebates earned by the account owner from spending. Total purchases are reconciled and rebates are paid monthly. Each of the Personal Currency cards have a full array of competitive affinity rewards and features. Although these are not true earnings, affinity rewards represent a price cut or discount by accumulating points and redeeming the points with the provider or vendor. All four partition accounts offer gradient share rewards (GSRs), where shares of the system's Class A common stock and 70% Warrants A are provided free. The number of free shares issued is based on initial deposit amounts and the maintenance of specific average daily balance requirements.

The second partition account, the higher yield savings account, offers the same gradient share rewards as the demand deposit partition accounts. In addition, the account owner earns a variable rate of interest, computed on the account's average daily balance, tied to the interest earned by the system from the investment of sweep balances placed in overnight government securities. These accounts are reconciled monthly and the net interest earned from these investments is split 50/50 between the system and the account's owner/shareholder.

The third and fourth partition accounts, the money market investment account and the brokerage account, each produce earning for the system and the account owner/shareholder. These accounts pay the prevailing money market interest rates to the account owner and the system earns the margin between the prevailing market rates and what is actually earned by the money market investment. Accounts are reconciled monthly and interest is paid monthly, based on average daily balance sweep investments. Both of these accounts offer the identical gradient share rewards as the other two accounts, based on initial deposit amounts and average daily balances.

3. Shares of Class A Common Stock

Shares of the system's Class A common stock, and/or other securities, are to be provided for free to a predetermined number of charter participants who accept the invitation to become a shareholder. The creation of the gradient share rewards (GSRs), based on initial deposits placed into the four partition accounts and the average daily balances maintained, is the main attraction of the PAKs.

The claim that the point-of-purchase cards and devices used herein introduce a new species of Personal Currency cards is founded upon the issuing of equity securities to those who accept our invitation to participate. In order to preserve the equity driven aspect of our point-of-purchase card design, shares of the system's Class A common stock and 70% Warrants A are to be provided free under certain conditions. These conditions were fully discussed previously. The intention to attract a predetermined number of charter shareholders does not limit the number of PAKs available with free system securities and gradient share rewards.

The choice to target an initial predetermined number of charter shareholders is intended to provide a sufficient foundation to attract the full capitalization to fund the system. The ability to reach this objective with possible ease may require an expansion of the number of free PAKs with gradient share rewards (GSRs). The intention of the geocentric participation and teaming technologies is to encourage sharing about the options available within the system's environment. If the initial charter participants invite others to participate, more free PAKs would be required to fulfill these invitations. The Geocentric Earnings Matrix (GEM) is designed to accommodate the enrollment of others who wish to benefit from the system's equity and earnings structures.

4. Geocentric Earnings Matrix

Revenue sharing within the Geocentric Earnings Matrix (GEM). The invention of the GEM creates the fulfillment structure for earnings within the system's interdependent micro-economy. The design of the GEM positions individuals and teams in a productive and rewarding structure where all revenues generated by the shareholders, and by the system, are distributed commensurate with the actual contribution made by the participants to production.

5. Internal Rewards Points (Revenue Sharing Units (RSUs))

Internal rewards points (internal monetary equivalents (IMEs)) called Revenue Sharing Units (RSUs). The creation of monetary equivalents as the basis for GainShare earnings options are fully explained within the Geocentric Earnings Matrix log. RSUs are generated from a series of algorithms that permit variable inputs to determine accurate distribution of earnings generated within the GEM.

6. Access Keys

Access keys for the e-pipeline commercial exchange. The introduction of the e-pipeline commercial exchange places a new technology for the purchase and sale of goods and services into the marketplace. The e-pipeline intends to create a market for goods and services by listing these on an exchange that is a real-time trading market, not a retail market. The e-pipeline resolves what is understood to be the Winner's Curse. In auctions, the winner often pays a higher price than the value of the product because the bidding may push the price, not determine the price. In a trading market, there are similarities to an auction but the similarities are not exact. Rather than the buyers bidding against each other out of the desire to have the item being auctioned, in a market the item being sold is priced at the market by the seller. Based on the demand for the product, there may be no b.i.d. at the price the seller wishes to receive. In such a case, the product is sold at the market price. This may be lower than the seller anticipated but the product was placed on the market and the market determined the actual value of the product. The access keys to the e-pipeline, and to the secure pages of the system's web site, open nearly limitless possibilities for savings and earnings. Although the e-pipeline represents a new technology, it is based on proven economic and market principles.

At this time, a discussion of the preferred embodiment of the e-pipeline will be presented.

The system model is comprised of numerous revenue engines. Of these revenue engines, the e-pipeline commercial exchange is perhaps the most prominent in the design. Access to the e-pipeline commercial exchange is granted by way of access keys embedded within the PAKs. The mechanisms of the e-pipeline are constructed very similar to the operations of the modern electronic stock market exchanges, e.g. the NASDAQ or Archipelago. Instead of trading stocks, bonds, etc., the e-pipeline creates an organized market for the purchase, and sale, of consumer goods and services. The e-pipeline constructs a ready market, as listings from either buyer or seller, for these finished goods and services. The operation of the e-pipeline is in real-time and, as a market is made for the listing, there is an immediate sale and liquidity for the listing seller.

The e-pipeline creates a pricing mechanism by allocating goods and services based on the response for the demand for the products and services, not based on marketing and supply. Inherent in this system of market exchange is demand-based pricing that reflects, to the buyer, the true and present value of those goods and services. Unlike a manufacturer's suggested retail price (MSRP), where the goods are priced well above what reflects a reasonable mark-up for the retailer and then sold over a period of time through stepwise reductions, goods sold through the e-pipeline are priced for immediate disposal at prices that reflect supply and consumer demand. Items traded in this demand driven market can be sold below an MSRP, when demand is low. Likewise, some items will be sold at a premium because of high demand. In either case, the goods or services are sold at a price that reflects what the consumer is willing to pay, rather than an arbitrarily high MSRP or an artificially high-priced winning bid.

The e-pipeline serves to connect those in demand with those who can satisfy the demand. It is theorized that all products and services, including raw materials, are to be eventually traded in markets—not in stores or by wholesale distributors. There is currently an active and viable market for stocks, bonds, and a diverse selection of commodities. There is also an active market in other products, such as options and derivatives. It is not a stretch to assume that an active and viable market in consumer goods and services can be created. This web-based electronic market in consumer goods and services is a collage of the current e-commerce sites (i.e. online auctions, e-commerce portals, electronic malls, plus traditional outlet malls). However, the e-pipeline is much more than all of these popular e-commerce/outlet sites combined.

At the pinnacle of the dot-com boom, numerous organizations were developed around the idea of e-commerce. Unfortunately, e-commerce was still in its infancy and there was no clear understanding of how to become an organization successful at selling goods on the worldwide web. As a result, numerous companies sprang up, bringing with them huge market capitalizations and slim chances of success. The notion of purchasing your pet supplies from a web site (instead of the local pet shop) and buying greeting cards from another web site (instead of the local Hallmark™ store next to the pet shop) was completely absurd. Each of these purchases brought along with them separate shipping and handling charges that caused prices to go into the hyper-retail realm. Only a few years transpired before investors realized that companies of this type had flawed business plans and were not sound investments. The resulting crash in the markets is still being felt today. Consumers, as well as investors, now have a better understanding of what works in today's marketplace. This increased awareness led to a shake-out, and a better understanding of what works and what doesn't.

Even though consumers have a better understanding of what works and what doesn't, there is a limited selection of e-commerce options from which to choose from. Although online auctions are very popular, there are numerous issues (including—fraud and high transaction fees) that have been associated with even the most popular sites. Many of the new web-based organizations are a knock-off of the internet auction design. Even those sites claiming to provide a portal for the sale of “overstocked” goods have auctions as part of their business plan. Whereas consumers may be aware of auction fraud, most of the consumers are not familiar with the “winner's curse” that accompanies their winning bid. The “winner's curse” occurs because, on average, the highest bidder in an auction is most likely to have overestimated the objects value and, as a result, overpays for the object. The “winner's curse” disappears only if the consumer is aware of the market price of the product. The e-pipeline commercial exchange eliminates fraud (through its independent internal review board) and eliminates the “winner's curse” (the consumers set the market price based on demand). Changing the market from a supply and marketing based economy to a demand based economy is a 180 degree change from the concept of internet auctions, and is definitely a novel application of e-commerce.

The e-pipeline commercial exchange is designed to perform like an electronic securities market. The detailed structure is discussed later in this document. There are two ways to approach transactions on the exchange: the supply side and the demand side. From the demand perspective, an individual or a team of individuals will create a demand for a product or service. The suppliers are made aware of the demand when an order is placed for the product or service. The consumers may also put in a bid price designating what they are willing to pay for the product. The supplier may counter with an ask price, reflecting what he is willing to sell the item for, or the supplier has the option of filling the order at the bid price. If the consumer does not accept the ask price, the consumer may counter with a new bid price or the consumer can let the order stand until a supplier fills the order at the consumer's bid price. The advantage to the consumer is that his/her buying power is increased because there are other consumers who are participating in the Interdependent Micro-Economy (IME) that are also placing bids with the suppliers. It is the role of the supplier to offer a price favorable that will move large quantities of product within a 24-hour period. The supplier benefits for that reason, also. The supplier is able to move large quantities of goods in a relatively short period of time. The advantage to both the consumer and supplier is that the goods are sold at a market price, where the consumer is paying a fair price and the supplier is receiving a fair price. A dual gain situation is created for all participants involved.

From the supply perspective, a supplier has the ability to merchandise or liquidate excess production capacity or inventory in a relatively short period of time. The supplier can make a supply of goods available through the e-pipeline at a price that is set by the market makers. These goods will be priced fairly (described later) and at a level that would entice consumers to purchase the goods. If the demand is tepid, the price will fall to stimulate demand. Conversely, if there is a high demand for the product, the price will rise until the demand is reduced. The consumers are creating pricing points for the product based on demand. No participant will pay more for a product than they feel the product is worth to them. They can simply wait until demand is lowered and then purchase. The consumer does, however, run the risk of not being able to purchase the product at any price because of depletion. This stimulates an active market. Product demand is monitored until all offered products are sold.

One goal of the exchange is to offer a marketplace for quick disposal of excess inventory and excess production capacity. However, small businesses could use the exchange as a means of purchasing goods at near wholesale pricing based on the buying power of the exchange as opposed to their individual buying powers. The exchange creates leverage for all of its participants. If, for example, a clothing manufacturer has excess inventory at the end of the year, that manufacturer has the ability to rid itself of that inventory in a matter of days by offering the inventory for sale on the exchange. The pricing will reflect what the market is willing to pay and will eliminate the need for intermediate markdowns over a matter of weeks or months. It is anticipated that some consumers will pay higher prices. Some will pay lower prices. The prices paid, however, reflect the present value of the products to the consumer. On average, the prices paid will reflect a substantial discount off list prices.

As e-commerce matures, demanding consumers will expect more sophisticated methods of purchasing. Purchasing that is demand (consumer) driven is one method that consumers will eagerly embrace. The e-pipeline commercial exchange represents a closed economy that is demand driven. Consumers pay a price based on their needs and desires, not some arbitrary price that is set by a retailer. On the other hand, the e-pipeline offers suppliers a large population of consumers that are ready to purchase if the price is right. The e-pipeline commercial exchange creates a symbiotic relationship between consumer and supplier.

A generalized diagram of the e-pipeline commercial exchange is shown in FIG. 2.

For the purpose of governance, it is envisioned that the system will establish an Internal Regulatory Board (IRB). This board is independent from the operations of the organization. The IRB is arms-length and is comprised of up to five individuals or firms acting as contract resources. The compensation for the IRB comes directly from transactions fees that are generated from use of the e-pipeline. It is mandated that each IRB board member is to be a shareholder of the system. The rules and regulations that are composed by the IRB are consistent with those rules and regulations governing the operations and management of comparable trading market exchanges. Areas of enforcement include compliance with regulations, truth in advertising, and satisfactory completion of each transaction by buyer and seller. The IRB is also responsible for coordination and monitoring of listing accuracy (including quantities available) and transaction settlement. The IRB will also compose rules and regulations governing sales completion procedures and merchant standards. Each product or service must comply with all of the regulations of the IRB before listing onto the exchange is allowed.

Although the exchange has been explained in detail earlier, a brief summary is included here to maintain continuity of thought. The e-pipeline commercial exchange operates in an electronic environment. This is a 24-hour, 7 day per week, trading market that matches demand with supply. The product mix presented on the exchange is determined by the demand generated by the participants, who are qualified buyers, in the IME. All of the participants are shareholders in the system and they have access keys to purchase on the exchange. They are open to purchase from the exchange all offerings up to the amount in their e-pipeline cash account. It is also anticipated that customers will have the ability to use charge cards.

A person who desires to place an order through the e-pipeline will key in a request, confirm the products or services wishing to be ordered, and execute the order. The order will be filled at current market price. As the design of the exchange progresses, there will be more sophisticated means of order placing, e.g. limit orders or options. As the exchange operates in real time, the merchants (sellers) of products and services may adjust the asking price to meet the demand of the market. This with the interchange between the owners of the seats on the exchange (brokers) and owners of the listings, which are held by the owners of the access gates (dealers). Both of these functions have the obligation to place the products and services on the exchange at a favorable, or lesser, price than the exact product is available at through retail in the general marketplace. In principle, this is possible because of the leverage available for the exchange. Unlike a retail store, the population of shareholders has indicated what products or services are desired for immediate purchase (demand position economics). The exchange, unlike a retail store, fills orders of demanded products. The exchange takes away the merchant overhead and inventory cost associated with the traditional retail setting.

The exchange is a closed market for the shareholders of the system. It is anticipated that merchants and manufacturers will offer into the exchange goods and services at no more than 5% above wholesale, permitting the e-pipeline to satisfy its buyers at no less than 15% below retail. This creates a more profitable arrangement for merchants (who are encouraged, if not mandated, to be shareholders), rather than selling wholesale. This places the remaining margin between wholesale and retail to be distributed to the system, as owner of the exchange. The margins, shipping and handling charges, and transaction fees are then distributed to administrative costs, funding of other components of the exchange, Revenue Sharing Units (RSU's), and any declared dividends.

When dealing with manufacturers direct, the manufacturer may choose to offer to the exchange production below wholesale in order to move large quantities or to expand production or product lines. The final prices on the exchange, ultimately, are to be determined by the market. The seats on the exchange have the obligation to monitor and balance prices with supply and demand. Although it is anticipated that most goods and services listed on the exchange will have an offering price of no less than 15% off retail, a scarcity of certain goods, coupled with an increased demand, could cause the goods to be offered at a higher price.

On first glance, the exchange may be confused with some of the current auction offerings. Although the e-pipeline commercial exchange is considered a continuous auction, it is not like an eBay auction because there are no timed sales or bidding against an asking price known to artificially drive up a price (winner's curse). It is not like an Overstock.com, which is merely an electronic outlet mall. Nor is it like a Priceline.com, which requires an individual to offer a blind bid and the individual is never guaranteed the best market price. The e-pipeline commercial exchange gives the individual the best market price on each purchase by adjusting price with the dynamics of supply and demand. After all, the best market price is the price that the customer is willing to pay at that moment, even if that price is intrinsically based on the consumer's desire to be the first to own something. It is believed that all demanded products may be marketed on an exchange and the use of market dynamics is the superior method for determining the present value of a product or service.

Embedded in each shareholder PAKs is an Access Key for operating on the exchange. Once inside the exchange, the shareholder may search for current offerings or post a demand for purchasing a specific item. The items listed on the exchange are not limited to newly manufactured goods. Previously owned items are allowed to be listed as long as the merchant complies with all of the rules and regulations governing the exchange. If the item appears on the exchange for sale, the shareholder is able to purchase the item at market price or the shareholder, as the buyer, may offer a different price to see if the order gets filled. Similar to the stock markets, the shareholder can determine how long the order shall remain on the exchange (e.g. day, good till cancelled, fill or kill, etc.). This method of live exchange purchasing creates dynamic market interactions between consumers (demand) and merchants (supply).

Located between the seats and the e-pipeline commercial exchange are access portals. There will be 100 access portals allotted. Initially, there will be 50 access portals made available to charter exchange members, who will purchase these access portals for a fee. The remaining access portals that are not offered for purchase will be kept in reserve and released at the discretion of the organization. The access portals represent a passive investment into the e-pipeline commercial exchange. The charter exchange members are purchasing the right to share in the gross revenues generated from the e-pipeline commercial exchange. These access portals are the only means of ingress onto the exchange on the supply side. Consequently, all transactions that occur on the e-pipeline commercial exchange must flow through the access portals. The charter exchange members will receive an equal share of a revenue sharing pool, which will consist of a percentage of the gross revenues that are generated by the exchange. Any revenue that is generated through this revenue sharing arrangement is placed, by direct deposit, into the charter exchange member's partitioned accounts.

Related to the charter exchange member's access portals are the shareholder's access portals. Movement through these access portals is granted via the access keys that are included in the shareholder's PAKs. The access keys will allow the shareholder to have direct access to the e-pipeline commercial exchange. The shareholder's access portals represent the demand side portals. The shareholders will place funds into a demand deposit account and these funds can be used to purchase the goods and services offered on the e-pipeline commercial exchange. Similar to the charter exchange member's access portals, only shareholders may access the e-pipeline commercial exchange through the demand side portals. They are closed to anyone else. Anyone wishing direct access to the e-pipeline commercial exchange must become a shareholder.

The member seats on the exchange are accountable for confirming the shareholder demand for specific goods and services listed on the exchange. The seats interact with the interchange to verify that the qualified goods and services to be listed on the exchange are offered for immediate sale and at prices that are in line with the exchange market pricing policies. The seats are the arbiters of the buyers and sellers, and are the market makers in demanded goods. This is accomplished by attempting to keep the offering price stable by monitoring demand and volume in the sale of goods and services, and regulating qualified supply into the exchange. The goal of the exchange is to satisfy both the buyer and the seller. It is the responsibility of the seats to ensure that both consumer (demand) and producers (supply) are balanced to create satisfaction and value for all participants.

Between the seats and the gates is an interchange that properly places the merchant's goods and services onto the exchange. This includes placing the offerings with the proper seat specialist that makes a market in these categories of goods and services. The interchange also serves as a negotiation platform for pricing and compliance with the regulations of the exchange. The function of the interchange is to solicit more choices, higher quality, and better prices for the products and services mix on the exchange. The interchange receives a continuous feed of demanded products and services from the shareholder population and posts these on the demand position of the exchange marketplace for the gates to search for merchants to supply the goods and services. The compensation for the exchange will come from a transaction fees collected from exchange purchases.

All product and services categories enter the e-pipeline through access. The gates function as dealers of products and services listed on the exchange. They may represent many or a few vendors or merchants within the commercial category they operate. Gates interact with the interchange to determine the merchant's compliance with exchange regulations, as well as verification of pricing, quantity of goods, and quality of goods. The gate would have qualified the merchant as a member of the exchange, and that the merchant has registered with the clearinghouse for compliance of the merchant with the e-pipeline's fulfillment strategies. If the merchant is not a member of the exchange or a shareholder, the gate invites the merchant to list on the exchange and become a shareholder. The gate represents the merchant as its agency in negotiations with the exchange. The merchant may participate in the negotiations with the exchange, but not without the representation of the gate. It is the gate's responsibility to maximize the merchant's position while preserving the standards of the exchange. Once the gate clears the merchant's offering with the interchange, the offering is listed on the exchange and a market is made in the offering by the seat. The offering opens with a price that may be adjusted up or down, depending on the demand for a product at a particular price point. It is the responsibility of the gate to place the proper listing into the interchange, ensuring that the price is correct and that the offering expires properly. An offering can expire either because the quantity offered is sold or there are no orders for the offering at the prices listed. If there are no sales or orders in any 24 hour period, the listing is canceled. The offering may be re-listed at a different opening price on the next 24 hour open cycle. The exact rules of listing can vary. However, this general overview should be sufficient for descriptive purposes.

Operating between the gates and the fulfillment terminals is a clearinghouse. This is an electronically driven service where gates, that represent merchants on the exchange, interact to ensure that logistics are in place to complete buy/sell transactions. If confirmation is not provided by the clearinghouse, the merchant cannot list the items for sale on the exchange. Additionally, the clearinghouse acts as a confirmation center for verification that fulfillment terminals are equipped and contracted to move the merchant's goods as listed.

The terminals are the providers of the logistical fulfillment services. These services include shipping, handling, delivery, and related risk insurances. In order to ensure rapid, and low cost, delivery of traded goods, it will be necessary to contract with major domestic and international shippers. The ability to secure regional storage and distribution contractors is also important to the order fulfillment process. It is envisioned that coupling the unique market qualities of the e-pipeline commercial exchange with a highly efficient logistics program will make the system a highly effective organization.

The Media Desk is an adjunct to the e-pipeline commercial exchange. The Media Desk will coordinate many of the public relations functions of the exchange. Because the exchange is closed to non-members, there must be a function linking the exchange to outside interest. This function of the Media is deemed crucial to the growth of the Interdependent Micro-Economy (IME). Any person with access to the internet may access information such as press releases and product information. The Media Desk will also have the responsibility to coordinate the internal (directed to members of the IME) and external (directed to non-members) advertising. It is important that an individual or organization who has interest in becoming a member of the IME is allowed an opportunity to obtain information concerning the IME. A person would be allowed to access the non-critical but informative portions of the IME, information concerning the system, product analyses, press releases, and external advertising. External and internal advertising is an effective way to generate income for the system. Advertising will also allow merchants to create product awareness and, subsequently, demand, both inside and outside the IME. Well placed advertising can stimulate growth of the IME because non-members would have to join in order to participate. Another function of the Media Desk is the compilation of sales data to prepare charts related to sales. These charts, similar to an exchange, will display such data like 52-week highs, 52-week lows, intraday charts, and long-term sales information. The Media Desk will also compare product and service indices—similar to the Dow 30, NASDAQ 100, etc. This treatment of data reinforces the system's concept of a market-based, demand economy to both the members of the IME, as well as to those non-members who are expressing an interest in the system.

Presented herein is a general outline for the e-pipeline commercial exchange. The goal of the system is to operate the e-pipeline commercial exchange similar to the capital markets exchanges. It is envisioned that eventually most products and services will be sold in a market-demand fashion, not in your traditional retail style. On-line auctions have inherent problems, such as “winner's curse,” the opportunity for fraud, and high transaction fees. Other e-commerce sites are merely a knock-off of the auction style of retailing, or they are electronic malls or electronic retail outlet sites. In all of the above examples, organizations of these types still use conventional means of pricing (in the e-commerce sense). Whether it is an auction or a mark-up from wholesale, market demand dynamics are not employed. The e-pipeline is also connected to the Geocentric Earnings Matrix (GEM), which allows the consumer (also shareholder) to participate in the equity of the company. The demand driven market created by the e-pipeline commercial exchange creates a micro-economy where everyone prospers. No other organization has put together such a comprehensive, leading edge, unique business structure where consumers and suppliers are on an equivalent playing field.

Having discussed the overall design of the system, and the e-pipeline, we turn now to a discussion of the geocentric earnings matrix (GEM).

Previously, we discussed a reward system that would represent a 180° difference from the structure of MLM or Network Marketing. The challenge is to derive a mathematical model that can capture the essence of the theory, and then devise a compensation schemata that, like MLM, encourages group participation but, unlike MLM, has a true reward structure without the “lure” consisting of generating income by adding members to a downline group (or network) or by selling hyper-retail priced products to those members who are in an individual's downline.

The concept of Geocentric Participation was invented to overcome the deficiencies of the MLM model. The prime directive of this geocentric model is to generate rewards that are earned from gained awareness and shared access, which gives rise to another unique term: GainShare. GainShare is the creation of an equity structure where earnings are gained from spending and investing as opposed to the MLM structure of earnings from new sign-ups. The geocentric model is one that can be visualized as a globe, with new GainShare teams emanating from a central core. These teams are distinct, yet highly dependent on each other, because all of the teams participate in the continuously growing equity of the company.

To improve upon the traditional MLM concept of “2-2-1-1” reward system, the Equity Participation Model utilizing the Geocentric Earnings Matrix (GEM) was designed. Simply stated, the MLM model, no matter how effective for those at the top of the pyramid, has no real advantage for those individuals who enter the “game” in its later stages. The Equity Participation Model—coupled with the GEM, in its simplest form, creates an equity structure where all of the participants are also owners of the company. As the equity value of the company grows, so does the value of each participant's share. This is not true in the MLM model, where the participant is only viewed as a customer, in the most remedial definition of the concept, and not as a co-owner. Being a co-owner allows each individual to share in the overall success of the company, not just in the success of their downline. The Geocentric Earnings Matrix attempts to value the participation of each team member (co-owner) by identifying and placing a value on the contribution of each participant.

The one similarity that is shared between the Geocentric Earnings Matrix and MLM would be the concept of group building. In the GEM, group building is referred to as team building. The similarities begin and end at the group, or team building concept. In the GEM, the size of the team is only one aspect of the total earnings plan, as opposed to being the only aspect. There are seven identified aspects, or attainments of the total earnings plan in the Equity Participation Model. The seven attainments are contained within the scope of the GEM. These seven attainments are defined as layers an individual can navigate through, with his or her achievements in the Interdependent Micro-Economy (IME) being the vehicle that is employed.

The seven layers were selected for their ability to define and reward each individual's participation in the IME. The lowest layer, Rebate and Dividend, is available to those who would want to minimally participate in the IME. The Rebate and Dividend layer consists of rewards for utilizing the point-of-purchase card and the e-pipeline commercial exchange. Layer 2 is a time measurement, and rewards the individual for the cumulative time spent participating in the IME. Layer 3 is a team building layer, which serves to encourage an individual to participate in team building. Movement through these three layers is relatively easy. Layers 2 and 3 represent time layers and, within these layers, points are rewarded for even a minimal level of participation. The individual, even if contributing on a minimal basis, continues to add some value (no matter how marginal) to the overall success of the organization. The individual will receive points that reflect the amount of time he has been participating as an individual (Layer 2) and he will earn additional time points when he decides to participate in team building (Layer 3).

Layers 4 and 5 represent individual achievement layers. Layer 4 is a measure of the growth rate (team building, savings, and spending) of an individual. The Geocentric Earnings Matrix recognizes savings in two distinct ways. Savings are recognized as 1) the amount of money the individual has put aside for investing (portfolio building) and 2) the amount of the monetary savings an individual has achieved as a result of participating in the e-pipeline commercial exchange, or any other product/service offered through the system. Growth is a key component in the success of any organization, especially an organization that is new to the industry. Since team building, savings, and spending are independent of each other, the individual could navigate through these layers without adding new members to his team—a concept virtually unknown in the traditional sense of the MLM. Layer 5 is an individual volume layer, which measures the cumulative volume an individual has contributed to the IME. Once again, the individual can navigate through this layer without placing great emphasis on team building. However, team building can make this navigation much easier.

Layers 6 and 7 are reserved for those individuals who have come to recognize the power of the IME, and these individuals would like to maximize the benefits that may be received by way of their participation. Layer 6, like Layer 4, is a growth layer. Layer 6, however, is an inducement for an individual to take a more active role in team building and an active role in the overall success of the teams. These teams are formed as a result of the expansion of teams formed by members who were invited to join, and by their “sub-teams,” and so on. This concept is in no way equivalent to the MLM “group-building” process because the individuals involved in the system are not receiving a percentage of the “take” that is moving upstream; they are, as shareholders and participants, being rated on a point system that, when refined, will value the individual's overall contribution to the success of the organization. The individual will receive compensation based on the value of the overall contribution as it relates to the success of the organization, not as it relates to the success of the individual's team building abilities. Layer 6 is a measurement of the individual's ability to manage the growth in his or her expansion teams. Layer 7 is a measurement of the individual's ability to manage and maintain the overall volume in his or her expansion teams.

The Geocentric Earnings Model provides a point system that rewards an individual for his or her own contributions to the team building process. The success of an individual is reflected in his ability to 1) maximize his or her use of the IME and its products and services, 2) encourages others to participate in the IME, and 3) encourages others to maximize use of the IME. The point system is structured to reward an individual for overall achievement (equity building) as opposed to achievement in down-line formation or selling of hyper-retail priced products. The GEM is designed to foster a teamwork, team building format that will encourage individuals to outperform each other, as well as encouraging a “team of teams” to compete against each other for a share of the revenue of the organization. This share of revenue is conceptualized in what are labeled as Revenue Sharing Units (RSU's).

There are eighteen listed inputs that contribute to the Geocentric Earnings Matrix. These inputs contribute to an internal point scoring system used to rank each individual and each of the team expansions. The purpose of the point system is to devise an equivalent measure that normalizes the dollar amounts spent and saved to the number of individuals that are added into the team expansion. In the final compensation model, for example, an individual could be rewarded 1 point/$1,000 of spending and 1 point/individual added to the team expansion. The individual points are totaled for an overall measurement of team performance.

A Revenue Sharing Unit (RSU) is the internal reward that is received by the participant. RSU's will work like an electronic security that is only used inside the organization. The organization will issue a fixed amount of RSU's (e.g., 10,000,000), whose value will be determined by the final distribution that is declared at the end of a specified period (perhaps monthly). Simply illustrated, if the organization distributes $10,000,000, the value of the RSU's are $1.00 each, or if $20,000,000 is distributed, the value of the RSU's is $2.00 each. The amount of the RSU's will remain fixed, while their value can float—similar to a share of stock—based on the distributions that are made by the organization. This concept serves three purposes: 1) to give each individual an incentive to earn as many RSU's as possible, 2) to give each individual an incentive to increase RSU value, 3) to serve as an excellent visual model for the understanding of the reward system, and 4) to further the intentions of the organization—namely, the promotion of savings and investing in securities.

Since the RSU's value is determined by the revenue distribution the organization is sharing with the participants, it is necessary to receive a better understanding of the distribution. A simple diagram is given below:
Individual→Invited Participants→Sub-teamsΔad infinitum

The above is a simple description of the Team Structure. A core individual who has successfully invited others to participate, and these participants are forming teams, and their invitees are participating and forming teams. The number of individual points are tallied and then combined for a “Team of Teams” (TOT) score. These TOT scores are combined to obtain the total number of points earned. Each TOT will receive a pro rata distribution of RSU's, whose value is determined by the organization. Each individual will receive a pro rata distribution of the TOT's RSU's based on the amount of points the individual has earned. The dollar value of the RSU's are then placed into the individuals account. The number of points an individual earns is based on eighteen inputs. These inputs are detailed later in this discussion. However, in summary, the inputs are a measure of “individual only” achievements and “team growth” achievements. These inputs are compiled and scored on a monthly basis, enabling points and, subsequently, earnings to be awarded on a monthly cycle.

The layering of rewards is the strong point of the Geocentric Earnings Matrix. An individual can determine his or her own earning's destiny, whether it is just simple participation or participation coupled with team building. The GEM allows an individual to visualize the value of his or her participation, along with rewards that are realistically achievable. By utilizing this layering of achievement system, a more rational and more workable earnings model can be accomplished. This model rewards individuals because of the value they have contributed to themselves as co-owners, and not some artificial value that is present in the traditional MLM compensation scheme. In the Equity Participation Model (where the GEM is embedded), income is produced at every layer of participation and each individual can build equity in a to-be-publicly-traded company. What better incentive to join and promote an organization?

Inputs for the Geocentric Earnings Matrix

The following are the metrics used in calculating the points awarded using the Geocentric Earnings Matrix. These inputs are used to evaluate the performance of the individual as he or she progresses through the layers. This system is designed to reward performance based on multiple inputs, thereby allowing an individual a chance to succeed based on their own individual goals as opposed to, e.g., the number of individuals they are able to “sign up” or the amount of good sold through a hyper-retail priced system of sales. Theoretically, an individual could advance through the layers with minimal team building by encouraging those on his team to focus more on spending events (card and e-pipeline purchases) and savings events (portfolio building and retail savings earned on the e-pipeline). While it would be optimal that each individual would have a desire, and incentive, to share their experiences and opportunities with others, minimal team building, coupled with spending and savings events, will have the effect of adding value to the system. Currently, there are eighteen identifiable inputs that are used in the Geocentric Earnings Matrix.

The eighteen inputs are as follows:

1—Cumulative Time Participating (T_{C})—A measure of the total time an individual has participated in the IME. There is no minimum level of participation required in order to receive cumulative time credit.

2—Cumulative Time in Team Formation (T_{TC})—A measure of the amount of time an individual has successfully participated in adding new members to his or her team. The successful addition of three individuals triggers the clock in this category.

3—Individual Spending (P_{I})—A measure of the monthly spending generated by each individual. Monthly spending will include debit card purchases and purchases generated through the e-pipeline commercial exchange.

4—Cumulative Spending (P_{IC})—The summation of an individual's monthly spending as described in P_{I}.

5—Individual Adds (A_{I})—A measure of the number of new participants an individual is responsible for successfully inviting to join, measured on a monthly basis.

6—Cumulative Adds (A_{IC})—The summation of the number of new participants an individual has added since joining the IME (summation of Individual Adds (A_{I})).

7—Team Spending (P_{T})—The total spending generated by the team expansion, exclusive of the individuals production, measured on a monthly basis.

8—Team Adds (A_{T})—The number of individual's new team members added to an individual's team expansion, measured on a monthly basis.

9—Cumulative Team Spending (P_{TC})—The summation of the total spending of an individual's group expansion, exclusive of the individual's cumulative spending.

10—Cumulative Team Adds (A_{TC})—The summation of the number of participants in an individual's team expansion, exclusive of the number of members in the individual's immediate team (all members directly invited by that individual).

11—Monthly Portfolio (S_{I})—The monthly amount an individual contributes to his savings and investment portfolio, including earnings on those savings/investments, using an average daily balance method, or some other appropriate measure.

12—Sustained Portfolio (S_{IC})—The total value of an individual's savings/investment portfolio, including deposits and earnings, using a monthly average or any other appropriate measure.

13—Monthly Portfolio, Team (S_{T})—The monthly amount an individual's team expansion contributes to their savings/investment portfolio, exclusive of the individual's contribution to his or her savings/investment portfolio.

14—Sustained Portfolio, Team (S_{TC})—The total value of an individual's team expansion, including deposits and earnings.

15—Purchase Savings, Individual (E_{I})—The monetary value an individual has saved by using the e-pipeline commercial exchange or any other purchasing service offered by Co-Owners, Inc. These savings are calculated by subtracting the actual price paid for the product or service from the suggested retail price.

16—Cumulative Purchase Savings, Individual (E_{IC})—The summation of the total savings earned from the individual's use of the e-pipeline commercial exchange.

17—Purchase Savings, Team (E_{T})—The monetary value an individual's team expansion has saved by using the e-pipeline commercial exchange or any other purchasing service offered by Co-Owners, Inc., exclusive of the individual's own purchase savings.

18—Cumulative Purchase Savings, Team (E_{TC})—The summation of the total savings earned from the individual's team expansion's use of the e-pipeline, exclusive of the individual's own savings.

Contribution Of Inputs To The Geocentric Earnings Matrix

The eighteen inputs that have been identified are used to calculate the number of points an individual will receive in the Geocentric Earnings Matrix. The GEM consists of seven layers of attainment, which an individual must earn the right to transfer from one layer to the next layer. Once the individual has attained a layer, they cannot move backwards. The value has been added to the organization and the individual will continue to receive the benefits gained from his contribution. The proposed structure is as follows:

Layer Description and Proposed Inputs

Layer 1—Rebates/Dividends (RD₁). The proposed inputs are Subsets of Individual Spending (P_{I}), depending on purchases and negotiated rebates, and any company authorized dividend.

Layer 2—Individual Time (T_{I}). The proposed inputs are Cumulative Time Participating (T_{C}).

Layer 3—Time in Team Formation (T_{T}). The proposed inputs are Cumulative Time in Team Formation (T_{TC}).

Layer 4—Individual Sustained Growth (G_{I}). The proposed inputs are Monthly Spending, Individual (P_{I}), Monthly Adds, Individual (A_{I}), Monthly Portfolio, Individual (S_{I}), Monthly Purchase Savings, Individual (E_{I}).

Layer 5—Cumulative Volume, Individual (V_{I}). The proposed inputs are Cumulative Spending, Individual (P_{IC}), Cumulative Adds, Individual (A_{IC}), Sustained Portfolio, Individual (S_{IC}), Cumulative Purchase Savings, Ind. (E_{IC})

Layer 6—Sustained Growth, Team (G_{T}). The proposed inputs are Monthly Spending, Team (P_{T}), Monthly Adds, Team (A_{T}), Monthly Portfolio, Team (S_{T}), Monthly Purchase Savings, Team (E_{T}).

Layer 7—Cumulative Volume, Team (V_{T}). The proposed inputs are Cumulative Spending, Team (P_{TC}), Cumulative Adds, Team (A_{TC}), Sustained Portfolio, Team (S_{TC}), Cumulative Purchase Savings, Team (E_{TC})

Description of Layers

Layer 1—Rebates/Dividends (RD₁)

The Rebate/Dividend layer is the most basic layer of the GEM. A person in this layer is not actively participating in team building, but is making use of the point-of-purchase cards and devices, as well as participating in the e-pipeline commercial exchange. Rebates earned from the point-of-purchase cards (described as the earnings feature with each spending event) will be awarded to card users based on rates that have been negotiated with card issuers. Rebates awarded through the e-pipeline purchases will be based on rates negotiated between the Seats (Brokers) and Gates (Dealers) of the system and the suppliers of products and services. Dividends will be distributed to each co-owner (shareholder) according to the quarterly dividend distribution declared by the organization. All participants in the Interdependent Micro-Economy (IME) are eligible for rebates and dividends, no matter what level of attainment they may have achieved. The health of the IME is dependent on individuals taking an active role in the economy. There must be some inducement or incentive to keep the individual as an active participant. Rebates offer some incentive, but perhaps, not enough.

Layer 2—Individual Time (T_{I})

If rebates are not enough, then how does one measure an individual's contribution to the success of the IME? Time is one of the critical factors in this measurement of success. As long as an individual is in the economy and producing within the economy, he or she has some measurable worth to the economy. The GEM is designed to reward the individual for remaining in the economy—even if that individual chooses only a marginal contributing role. Even at the basic level of spending, the individual will contribute to the overall success of his or her team, as well as to the overall success of the IME. Since everyone is making a positive contribution, everyone is awarded points in this layer, given that they are using their point-of-purchase cards at least once per month (or at some other rate determined as the GEM evolves). T_{I} points are awarded based on the number of months an individual has been participating in the IME. T_{I} points start accruing after 30 days participation in the IME.

After 30 days participation, it is anticipated that a team leader would properly guide an individual through the benefits and rewards of participating in the IME. This guidance should give the new individual the desire to grow a team of their own. When the individual participates in team building, they are eligible to progress to the next layer. It is anticipated that an individual would be required to establish a team of at least three individuals (3-4-3 concept). After successfully inviting three individuals to join, the new team leader will then progress to the next layer.

Layer 3—Time in Team Formation (T_{T})

As each individual matures in this interdependent micro-economy, the benefits of their participation and their understanding of the system should increase to the point where they would be willing to invite others to join the IME. Individuals in this layer have successfully invited three new members to participate, and these new members have been participating for a minimum of 30 days. It should be duly noted that the intent of the GEM is not just one of team building. The goal is team building coupled with participation. Consequently, any reward system must incorporate a performance aspect. After successfully inviting three individuals to join the IME, the Layer 3 individuals can earn points for “Time in Team Formation (T_{T}).” As with T_{I}, T_{T} points are awarded based on the number of months an individual has been in the layer. In this case, the measurement is the number of months an individual has been actively participating as a team leader.

Team formation is not based on an individual's ability to sell a “hard” product or service. Team formation is merely an invitation to family, friends, co-workers, etc. to joint the IME, thereby being permitted to participate in the benefits and rewards that are offered to participants of this system. Unlike most, if not all, MLM's, there is no fee to participate, therefore, unlike MLM's, there is no money to move upstream. On the contrary, the new member will receive a point-of-purchase card, along with a basket of securities (share and warrants), based on the amount of funds deposited into the partitioned accounts that are made available through the system.

The IME's success is highly dependent on the addition of new members. Through the enrollment of new participants, the IME's leverage is increased because there will be a significant number of participants generating spending events, savings (retail and portfolio building), and purchases on the e-pipeline commercial exchange. The incentives offered in Layer 3 are necessary for the system to reach its enrollment goals without a huge capital outlay for other means of mass marketing. It is also critical that the new team members remain active in team growth. Individuals who are active in team formation for a sustained period are then moved to the next layer of attainment, Layer 4.

Layer 4—Individual Sustained Growth (G_{I})

An individual who has attained this layer is cognizant of the opportunities offered by the IME. Sustained growth implies that this individual is active in team formation as well as utilizing the products, services, and wealth building tools offered by the system and its affiliates. Points will be awarded for production—utilizing the point-of-purchase card, purchases and retail savings via the e-pipeline commercial exchange, and participating in the investment plans offered by the system or its affiliates. Additional points will be rewarded for people—the number of new team members that an individual has successfully invited to join the IME.

Any successful organization achieved its success through growth. Layer 4 was established to encourage participants to sustain their individual spending and savings, but also as a tool used to promote sustained team building. Individuals in this layer are believed to have become serious in their efforts to build wealth. Therefore, in addition to earning points in the GEM, these individuals will also earn points in the Essential Wealth category of a separate wealth building layer—which will be described in later writings.

After an individual has achieved a target level of sustained growth, the individual will then move to the next layer. The individual who has earned the right to move to Layer 5 is adding real value to the organization. This growth will lead to an increase in volume, which is captured in Layer 5.

Layer 5—Cumulative Volume, Individual (V_{I})

The goal of the GEM is to offer every incentive for an individual to perform to their maximum capabilities as they navigate through the IME. Individual growth is the metric in Layer 4, and the volume resulting from that growth is the metric for Layer 5. Cumulative volume is the summation of the people, spending, and savings the individual is directly responsible for adding to the IME. This measurement can be for the entire time an individual has been participating in the IME, or it can encompass a shorter duration, such as a year-to-date summary. In any event, an individual who has attained this layer is adding some serious horsepower to the economic engine. Once again, it is of the utmost importance to sustain their level of performance. By including volume incentives, the individual is encouraged to utilize all of the services of the system at every available chance. This incentive serves to keep the individual in the mindset of earning while spending. Furthermore, the desired outcome would also be one that encourages the individual to take advantage of the savings and investment opportunities offered by the organization. The individual is awarded points for spending, growth in their direct team, purchase savings, and participation in savings/investment plans. In addition to VI points, the individual will earn points in the Cumulative Wealth category of the previously mention, but not described, wealth building layers.

Layer 6—Sustained Growth, Team (G_{T})

After the achievement of the individual volume goals established in V_{I}, the participant will progress to Layer 6, Sustained Growth, Team. This layer was established to encourage team leaders to motivate others on their team to form their own teams, as well as encouraging those team members to actively and fully participate in all of the offerings of the IME. An individual that moved through Layers 1-5 has earned points towards the attainments that are directly related to them and under their control. However, an additional goal of the GEM is one that encourages a shared team environment, where all the team members are taking ownership in the success of their team and any subsequent teams that are formed by team members that they have invited to participate in the IME. In this layer, the members of an individual's team are forming teams and, to some degree, the individual has taken on a quasi-management function. It is anticipated that, because of the increased responsibilities, the rewards will be greater than for the first five layers. It is also anticipated that, in this quasi-management function, the individual is actively participating in promoting team building activities, as well as, actively promoting the use of all of the features that the system has to offer the individual. The individual could qualify for additional incentives offered by the organization that would encourage him or her to sustain his or her active role in the organization's growth. This individual will earn points for rate of growth—people and production—of the teams formed by members of his or her team. This individual will also earn Optimal Wealth points in his or her quest to attain the final wealth category, Permanent Wealth.

Layer 7—Cumulative Volume, Team (V_{T})

The final layer, Cumulative Volume, Team, is reserved for the most active members of the system. These individuals have engaged in active individual and team growth for an extended period. This incentive layer measures the sum total of the production of the teams that the individual is responsible for initiating. Related to Layer 5, Cumulative Volume, Individual (V_{I}), Layer 7 is an incentive that rewards the individual for active participation in encouraging others in the “Team of Teams” to take advantage of the products and services of the system. This individual is actively organizing team activities—including team meetings, team advising, leadership training, and other activities that are deemed necessary to promote the success of the teams. These team building activities are not to be confused with the quasi-motivational meetings that are held by traditional network marketers. In any successful corporation, there will be genuine leaders; individuals who have the experience and the ability to manage large groups of individuals. These leaders possess the skill sets necessary to further the organization's growth goals, not by using idiomatic buzzwords and “rah-rah” cheerleading, but with the drive, dedication, and determination that is required of a successful leader. Layer 7 is the ultimate layer of success in the system's GEM. The Layer 7 individual will received points based on the number of team members that he or she is indirectly responsible for inviting (those members invited by members of his or her team, and those members invited by members of their teams, and so on, ad infinitum). The individual will also receive points for the amount of spending, investing, and purchase savings generated by these individuals. This individual will also earn points toward Permanent Wealth in the separate wealth building model.

Movement Through the Layers

Movement through the layers is determined by a set of minimum criteria established for each individual layer. The criteria are designed to encourage and reward team members for their level of participation in the IME. Full participation requires an individual to perform equity enhancing activities, no matter what their current layer of attainment may be at that moment. These activities would include utilizing the point-of-purchase card, purchasing on the e-pipeline commercial exchange, building an individual savings and investment portfolio, encouraging others to join, and encouraging others to take advantage of the benefits offered by the system through its IME.

Layer 1 requires minimal participation and represents the rebates an individual would receive on card purchases, as well as rebates from the purchases of goods and services from the e-pipeline and any dividends declared by the organization. Movement to the next layer occurs after 30 days of participation.

Layer 2 is a time measurement and accumulates as long as the individual maintains a minimal level of participation in the IME. In order to move to Layer 3, the individual must participate in team building activities. After the individual has successfully invited three others (3-4-3) to join, the individual can move to Layer 3.

Layer 3 is the second time measurement. The amount of time, in months, that an individual has been participating in team building activities is accumulated in this layer. The participant may progress to Layer 4 after successfully inviting another three members (3-4-4) to participate in the IME.

Layer 4 is the rate measurement of the growth of the individual's spending, savings (both investments and purchase savings), and team building activities. This layer is an inducement to reward the individual for maximizing his or her use of the IME, and for active participation in team building activities. Reaching a target growth rate will permit the individual to progress to the next layer.

Layer 5 is an absolute measurement of the individual's production. This layer measures the total production of an individual from the date they initially participated in the IME. Movement to the next layer is contingent upon the individual meeting cumulative volume goals.

Layer 6 is a measurement of the growth rate of the teams that have been formed by an individual's direct team members, and the subsequent teams that were formed by them, ad infinitum. Layer 6 is the team growth incentive and it is expected that the individual's “Team of Teams” will attain a specified rate of growth in order to proceed to the next, and final, layer.

Layer 7 is the ultimate layer of the GEM. An individual is achieving well above the organization's expectations, and this individual is making an exceptional contribution to the organization's growth. An individual in this layer is rewarded points for the sustained volume of his or her “Team of Teams.” Currently, there are no defined layers beyond Layer 7. It is anticipated that subsequent writings will describe incentive and reward plans for those individuals who have mastered this layer. Part of those incentives would include moving through separate wealth building layers described earlier in this document.

Presented in this writing is the basic structure of the Geocentric Earnings Matrix. This system of “earnings for participation” is definitely a 180° difference from the MLM model in both its scope and its application. Individuals who are looking for a great deal more than the tired concept of 2-2-1-1 and hyper-retail priced products can appreciate the diverse opportunities contained within the layers of the GEM.

While the invention has been described with respect to preferred embodiments thereof, it will be understood by those skilled in the art that various changes in detail may be made therein without departing from the spirit, scope, and teaching of the invention.

What is claimed is:

1. A multilayer investment system based on geocentric participation, comprising:
a plurality of participant access keys organized in geocentric layers;
the inner geocentric layer of participant access key having an predetermined set of functions and privileges, and each succeeding layer of participant access keys having an extended set of functions and privileges in relation to the previous layer of participant access keys;
a variety of e-pipeline products to owners of participant access keys and others via electronic participation channels, the products further including a variety of financial products, including ATMs, and debit/credit cards;
means to relate financial transactions and e-pipeline purchases to particular owners of participant access keys, and to compensate owners of participant access keys as a result of the financial transactions and/or e-pipeline purchases based on the relationship between the enrolled member and the entity making the e-pipeline purchase and/or financial transaction.
